(19) United States
(12) Patent Application Publication
(10) Pub. No.: US 2008/0082707 A1
(43) Pub. Date: Apr. 3, 2008

(54) Non-blocking bus controller for a pipelined, variable latency, hierarchical bus with point-to-point first-in first-out ordering

(75) Inventors: Shail Aditya Gupta, San Jose, CA (US); David John Simpson, San Jose, CA (US)

Correspondence Address: BLAKELY SOKOLOFF TAYLOR & ZAFMAN, 1279 OAKMEAD PARKWAY, SUNNYVALE, CA, 94085-4040, US

(73) Assignee: Synfora, Inc.

(21) Appl. No.: 11/906,059

(22) Filed: Sep. 28, 2007

Related U.S. Application Data
(60) Provisional application No. 60/848,110, filed on Sep. 29, 2006.

(51) Int. Cl. G06F 13/18

(52) U.S. Cl. 710/110

(57) ABSTRACT

A method and apparatus is disclosed herein for a bus controller that supports a flexible bus protocol that handles pipelined, variable latency bus transactions while maintaining point-to-point (P2P) FIFO ordering of transactions in a non-blocking manner. In one embodiment, the apparatus includes a bus controller to receive a plurality of bus transactions at a first incoming port from a bus. The bus controller is configured to process the plurality of bus transactions in a pipelined manner, maintaining P2P FIFO ordering of the plurality of bus transactions even when the plurality of bus transactions take a variable number of cycles to complete.

### PRIORITY

The present patent application claims priority to and incorporates by reference the corresponding Provisional Patent Application Ser. No. 60/848,110, entitled, “Flex Bus Architecture” filed on Sep. 29, 2006.

### FIELD OF THE INVENTION

The present invention relates to the field of bus architectures and bus protocols; more particularly, the present invention relates to bus architectures and bus protocols that handle pipelined, variable latency bus transactions while maintaining point-to-point (P2P) first-in-first-out (FIFO) ordering of transactions in a non-blocking manner.

### BACKGROUND OF THE INVENTION

In computer architecture, a bus is a sub-system that transfers data, and possibly power, between computer components inside a computer or between devices. Buses can be used to logically connect multiple peripherals over the same set of wires or traces. Buses can also be used to directly connect a master device and a slave device. Buses that are used to connect multiple devices (e.g., multiple endpoints) together are referred to herein as shared buses. Buses that are restricted to directly connecting a master device and a slave device are referred to herein as P2P buses. The P2P bus denotes the entire path between a master device and a slave device. Most computers have both internal and external buses. An internal bus connects all the internal components of a host system or a device, such as the central processing unit (CPU) and internal memory. These types of buses are also referred to as a local bus, because they are intended to connect to the local devices, not devices that are external to the host system. An external bus connects to devices that are external to the host system or device.

A bus protocol is a set of guidelines or rules that are used in controlling, scheduling, and/or processing request and response transactions on a bus. A bus protocol is a convention or standard that controls or enables connection, communication, and data transfer between two computing endpoints. In particular, the bus protocol can be defined as the rules governing the syntax, semantics, and synchronization of communications between devices. Protocols may be implemented by hardware, firmware, software, or a combination of hardware, firmware, and software. The bus protocol may also define the behavior of a hardware connection, also referred to herein as a bus interconnect.

Typically, buses are controlled by a bus controller. The bus controller controls the data traffic on the bus by arbitrating or scheduling the data traffic according to a bus protocol as described above. In a typical bus, a requesting device sends a message to the bus controller to indicate that the requesting device has requested data to be transferred to or from a responding device. It should be noted that the requesting device could also be described as a master device, although it should be noted that the requesting device can eventually receive a response as well. Likewise, the responding device could also be described as a slave device that initially receives a request to which it is responds eventually. The request is put into a queue of the bus controller. The message may contain an identification code which is broadcast to all the devices attached to the bus. The bus controller prioritizes multiple requests that have been received, and notifies the responding device as soon as the bus is available to transfer data. The responding device takes the message and performs the data transfer between the two devices, such as by transferring data to the requesting device. Having completed the data transfer, the bus becomes available for the next request in the queue to be handled or processed by the bus controller.

Conventional System-on-a-chip (SoC) devices, which integrate various devices of an electronic system into a single integrated circuit, include buses that connect the various devices. These conventional buses are controlled according to conventional bus protocols. The conventional bus protocols, however, do not support pipelined, variable latency transactions with point-to-point FIFO ordering between a pair of requesting and a responding devices without blocking transactions between other pairs of requesting and responding devices. These conventional protocols either only support fixed latency transactions to ensure FIFO ordering, or the conventional protocols lock the bus until a variable latency transaction completes. Other conventional protocols use out-of-order processing and do not guarantee point-to-point FIFO ordering. In the latter case, the conventional protocols require complex matching schemes to match the request and response transactions since the transactions are processed out of order, such as using complex hardware reordering circuitry or complex software reordering schemes. For example, one conventional protocol uses tagging to manage out-of-order completion of multiple concurrent transfer sequences of requests and response transactions. These conventional protocol that use tagging to manage out-of-order transactions require complex bus controllers to manage the matching of tags for the request-response pairs. Another conventional protocol requires additional control in software to enforce ordering between read and write transactions even when they have the same tag.

### SUMMARY OF THE INVENTION

A method and apparatus is disclosed herein for a bus controller that supports a flexible, hierarchical bus protocol that handles pipelined, variable latency transactions with point-to-point FIFO ordering between a pair of requesting and responding devices, without blocking transactions between other pairs of requesting and responding devices. In one embodiment, the apparatus includes a bus controller that handles a plurality of bus transactions between a first pair of requesting and responding devices. The plurality of bus transactions are pipelined, variable latency bus transactions. The bus controller is configured to maintain FIFO ordering of the plurality of bus transactions between the first pair of requesting and responding devices even when the plurality of bus transactions take a variable number of cycles to complete. The bus controller is configured to maintain the FIFO ordering without blocking a bus transaction between a second pair of requesting and responding devices.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of one embodiment of a hierarchical system having multiple bus controllers that control buses at different hierarchical levels of the system.

FIG. 2 is a block diagram of one embodiment of the bus controller of FIG. 1 that is coupled to multiple master devices and multiple slave devices, at one hierarchical level, using shared buses and P2P buses.

FIG. 3 is a block diagram of one embodiment of a bus controller that is coupled to multiple devices and a memory controller, at one hierarchical level, using P2P buses.

FIG. 4A is a block diagram of another embodiment of the bus controller of FIG. 3 having buffers placed between the first and second devices and the bus controller.

FIG. 4B is a block diagram of one embodiment of a master device coupled to a slave device using stream buffers.

FIG. 5 is a timing diagram of pipelined bus transactions between a master device and a slave device according to one embodiment of the invention.

FIG. 6 is a flow chart of one embodiment of a method of operating a bus controller according to a flexible bus protocol that handles pipelined, variable latency transactions with point-to-point FIFO ordering between a pair of requesting and responding devices, without blocking transactions between other pairs of requesting and responding devices.

FIG. 7 is a timing diagram of pipelined bus transactions between two master devices and a slave device using P2P buses according to one embodiment of the invention.

FIG. 8 is a timing diagram of pipelined bus transactions between two master devices and a slave device using a shared bus according to one embodiment of the invention.

FIG. 9 is a block diagram of the internal arrangement of the second device of FIG. 1.

FIG. 10 illustrates an address mapping for multiple resources on the shared bus of FIG. 9.

FIG. 11 illustrates an address mapping for resources of the application engine of FIG. 1.

FIG. 12 illustrates an arbitration mechanism for maintaining the FIFO semantics according to one embodiment of the invention.

### DETAILED DESCRIPTION OF THE PRESENT INVENTION

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

### Overview

Described herein is a bus architecture that utilizes a bus controller that implements a flexible bus protocol to handle pipelined, variable latency transactions with point-to-point FIFO ordering between a pair of requesting and responding devices, without blocking transactions between other pairs of requesting and responding devices. The bus transactions can take place either on a P2P bus interconnect with local addressing or a shared bus interconnect with globally shared addressing. The P2P bus interconnect is a connection restricted to two endpoints, such as a master device and a slave device. Each P2P connection has its own independent address and data buses. The shared bus interconnect is a connection between multiple endpoints, such as multiple master and slave devices that share an address bus and the forward and return data buses. The bus controller facilitates transactions between multiple master devices and multiple slave devices at one or more hierarchical levels using the shared buses and the P2P buses. The master and slave devices may be, for example, memory controllers, memory, processing engines, processors, stream-buffers, interrupt controllers, microcontrollers, application engines, or the like. The bus architecture, as described in the embodiments herein, support a flexible bus protocol used as a communication protocol for data streaming using two-way handshake data channels, flexible buses for both shared bus transactions (e.g., globally addressed, arbitrated transactions) and P2P bus transactions (e.g., locally addressed, arbitrated or non-arbitrated transactions).

In one embodiment, there are two types of memory buses that are used in an application engine: the P2P bus and the shared bus. These two types of buses implement the same bus protocol, which is configured to handle pipelined, variable latency transactions with point-to-point FIFO ordering between a pair of requesting and responding devices, without blocking transactions between other pairs of requesting and responding devices. The P2P buses are restricted to have a single master device and a single slave device and use local device addresses for its transactions. The shared bus is a hierarchical bus supporting multiple master devices and multiple slave devices at each hierarchy level, while providing a single, global, relocatable address space for the entire system (e.g., application engine). In one embodiment, the single global address space may be relocated via a programmable base address. By having a programmable address space for the application engine, the application engine can be relocated in a system at different memory locations in the system address space. The resources of the application engine, however, have a predefined relation to the programmable base address. As such, the memory location of each resource of the application engine may be found using the programmable base address.

In one embodiment, the flexible bus protocol supports the following features: 1) full-duplex, independent, and unidirectional read and write data paths; 2) multiple data path widths; 3) split transactions (e.g., by splitting the transactions into request transactions and response transactions); 4) pipelined request and response transactions; 5) two-way handshakes on both the request and response transactions; 6) variable latency tolerance; 7) in-order request and response processing; 8) burst data transfer modes and normal transfer modes; 9) independent stall domains; 10) and critical path timing insulation for request and/or response transactions. Alternatively, the flexible bus protocol may be modified to support other features and provide other advantages.

In one embodiment, the flexible bus protocol includes the following global properties and provides the following advantages: 1) easy programming model; 2) high performance; and 3) scalable, modular, composable, and reusable designs. It should also be noted that these three properties of flexible bus protocols are often at odds with each other. The embodiments described herein are directed to balancing the properties to optimize the three identified advantages.

In one embodiment, the flexible bus protocol uses end-to-end first-in-first-out (FIFO) semantics to achieve the easy programming model. This allows interleaved read and write transactions between a pair of devices to be issued one after the other while maintaining sequential semantics without any intermediate software or hardware synchronization or flushing. In another embodiment, the flexible bus protocol uses a single global address space on the shared bus to achieve the easy programming model. This allows the compiler and linker to create a unique shared address for every object and be able to pass the unique shared address around as data to any other module in the entire application engine. The same object is accessible at the same address from any module in the system. In another embodiment, the flexible bus protocol uses direct local address space on the P2P connections to achieve the easy programming model. Since P2P connections are addressing only one device, direct local addressing saves address bits as well as makes the connection context independent. Alternatively, any number of combinations of these properties may be used to achieve the easy programming model.

In one embodiment, the flexible bus protocol uses pipelined transactions to achieve a higher performance. Pipelining helps to absorb the full latency of the transactions by overlapping them. In another embodiment, the flexible bus protocol uses direct P2P connects for high bandwidth transactions to achieve a higher performance. The direct P2P connections do not use the shared bus and therefore allow multiple pairs of requesting and responding devices to exchange transactions simultaneously. In another embodiment, the flexible bus protocol uses prioritized, non-block arbitration to achieve a higher performance. Prioritized arbitration allows a high priority requestor to connect to a responding device through the bus controller while a low priority requesting device is already waiting to get a response from its responding device. This non-blocking behavior is allowed as long as it does not violate the point-to-point FIFO ordering between the same pair of devices. In another embodiment, the flexible bus protocol uses a designated, highest-priority port (e.g., external master-device interface) for avoiding global deadlock and starvation conditions to achieve a higher performance. In hierarchical configurations, the external master device is given higher priority than internal master devices so that the internal bus controller can service incoming global requests even when some internal master devices are waiting. In another embodiment, the flexible bus protocol uses burst transaction modes to achieve a higher performance. The flexible bus protocol support variable length bursts across multiple hierarchies that lock down the grant path on multiple hierarchical levels until the burst is finished. The grant path can be setup using a dummy transaction or the first packet of the actual transaction. Alternatively, any number of combinations of these properties may be used to achieve a higher performance.

In one embodiment, the flexible bus protocol uses a hierarchical, multi-level shared bus to achieve scalable, modular, composable, and resusable designs. A hierarchical bus is scalable because transactions within a sub-system can happen in parallel without locking the entire system. In another embodiment, the flexible bus protocol uses timing insulation via buffering to achieve scalable, modular, composable, and resusable designs. Adding extra buffers does not change the nature of the flexible bus protocol because it handles variable latency transactions. Buffers may be inserted at hierarchical boundaries to provide hardware modularity of sub-systems. In another embodiment, the flexible bus protocol uses relocatable sub-system addressing to achieve scalable, modular, composable, and resusable designs. The relocatable global addressing provides software modularity of the system. In another embodiment, the flexible bus protocol allows different latencies for different slave devices to achieve scalable, modular, composable, and resusable designs. Alternatively, any number of combinations of these properties may be used to achieve scalable, modular, composable, and resusable designs.

In one embodiment, the flexible bus protocol is configured to have all the properties described above with respect to achieving an easy programming model, higher performance, and scalable, modular, composable, and resusable design. In another embodiment, the flexible bus protocol may include less than all of these properties.

In one embodiment, the apparatus includes a bus controller that handles a plurality of bus transactions between a first pair of requesting and responding devices. The plurality of bus transactions are pipelined, variable latency bus transactions. The bus controller is configured to maintain FIFO ordering of the plurality of bus transactions between the first pair of requesting and responding devices even when the plurality of bus transactions take a variable number of cycles to complete. The bus controller is configured to maintain the FIFO ordering without blocking a bus transaction between a second pair of requesting and responding devices.

In another embodiment, the apparatus includes a shared bus interconnect, a P2P bus interconnect, at least two requesting devices and at least one responding devices and a bus controller coupled to the requesting and responding devices via the shared bus interconnect and the P2P interconnect. The bus controller receives shared bus transactions and P2P bus transactions on the respective buses from the requesting devices that may have different latencies. The bus controller, implementing the flexible bus protocol, handles both the shared bus transactions and the P2P bus transactions in a pipelined manner while maintaining FIFO ordering of transactions between each pair of requesting and responding devices.

### Shared and P2P Bus Architecture

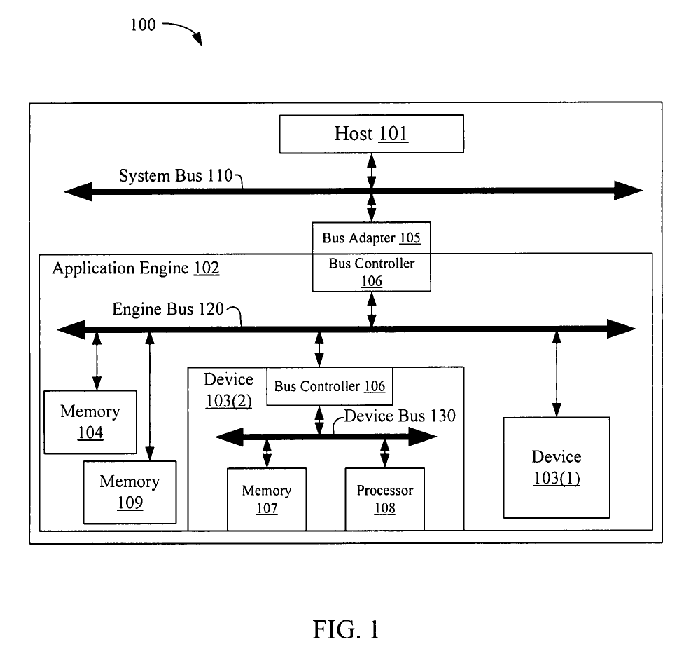

FIG. 1 is a block diagram of one embodiment of a hierarchical system 100 having multiple bus controllers 106 that each controls a bus at different hierarchical levels of the system 100. The system 100 includes a host 101 that is coupled to the system bus 110 at a first hierarchical level. The system bus 110 is an interconnect that couples the host 101 to various devices, such as an application engine 102 illustrated in FIG. 1. The host 101 maybe one or more primary processors (e.g., CPU) of the system. The host 101 is capable of executing a program by executing the program instructions that are stored in system memory (not illustrated in FIG. 1) and processing data. The host 101 is coupled to an application engine 102 by way of the system level bus 110 and bus adapter 105.

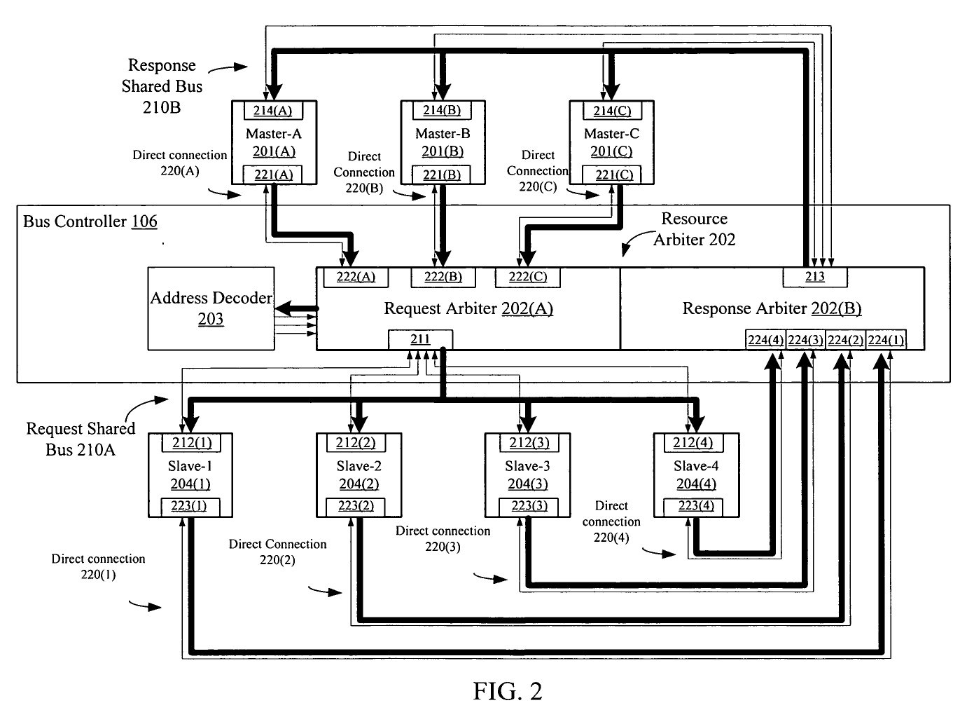

The application engine 102 includes a bus controller 106 that is coupled to the bus adapter 105. The hierarchical bus architecture of the application engine 102 may be a tree-like structure with this bus controller 106 as the root bus controller. As shown in FIG. 1, multiple levels of buses are connected to each other by bus controllers that form a bridge between two levels of buses. At each level there may be one or more devices that are connected to the bus at that level. The entire system of buses, bus controllers, and devices forms a tree structure. The bus controller 106 is coupled to the host system bus 110, via the bus adapter 105 as shown in FIG. 1. The bus controller 106 is described in more detail below with respect to FIG. 2. The bus adapter 105 is configured to convert transactions on the system bus 110 to be sent on different types of buses, such as the engine bus 120. In another embodiment, the operations of the bus adapter 105 may be implemented in the bus controller 106. The bus controller 106 is coupled to the engine bus 120 at a second hierarchical layer that is different than hierarchical level of the system level bus 110. The engine bus 120 is an interconnect that couples the various resources of the application engine 102, such as first memory 104, second memory 109, a first device 103(1), and a second device 103(2). The first and second devices 103(1) and 103(2) may be various types of devices, such as for example, one or more processors, processor arrays (also referred to as accelerators), microcontrollers, processing engines application engines, stream buffers, memory controller, interrupt controllers, bus adapters, or the like.

As illustrated in FIG. 1, the second device 103(2) also includes a device bus 130. The bus controller 106 of the device 103(2) is coupled to the engine bus 120 at a third hierarchical layer that is different than first and second hierarchical levels of the system level bus 110 and the engine bus 120. The device bus 130 is an interconnect that couples the various resources of the second device 103(2), such as the memory 107 and the processor 108. The device bus 130 includes a shared bus and P2P connections. The bus controller 106 of the second device 103(2) controls the device bus 130. The bus controller 106 also interacts with the engine bus 120 to communicate with the devices of the application engine 102, the host 101, or other components that are external to the device 103(2), such as the device 103(1).

In one embodiment, the system bus 110, engine bus 120, and device bus 130 are each controlled by a bus controller 106 that implements the flexible bus protocol according to the embodiments described herein. In another embodiment, the engine bus 120 and the device bus 130 are each controlled by a bus controller 106 that implements the flexible bus protocol, according to the embodiments described herein, and the system bus 110 is controlled by a bus controller that implements a separate bus protocol as known to those of ordinary skill in the art. Alternatively, other configurations are possible, such as different types of resources at different hierarchical levels. Also, it should be noted that other embodiments may include more or less hierarchical levels than described and illustrated with respect to FIG. 1.

In one embodiment, the system 100 may be a system-on-a-chip (SoC), integrating various components of the system into a single integrated circuit. The SoC may contain digital, analog, mixed-signal, and/or radio-frequency functionality. The resources of the system 100 may include one or more microcontrollers, microprocessors, digital signal processing (DSP) cores as the devices 103(1) and 103(2), and memory blocks including ROMs, RAMs, EEPROMs, Flash, or other types of memory for the memory 107, memory 104, and memory 109. The devices may also include such resources as oscillators, phase-locked loops, counters, timers, external interface controllers, such as Universal Serial Bus (USB) and Ethernet controllers, analog-to-digital converters, digital-to-analog converters, voltage regulators, power management circuits, or the like.

In one embodiment, the hierarchical bus architecture of the system 100 provides a single, byte-addressed, shared, global address space for the entire system 100. Creating the multi-level, tree-structured, hierarchical bus system is used to achieve a modular design. It should be noted that the system 100 includes one flexible bus at each hierarchical layer and each flexible bus is controlled by its own bus controller 106. All components (also referred to as modules) of the system can make a global memory request from the memory 104. The requesting components are considered master devices, while the memory 104 is considered to be a slave device. Also, the host 101, the first and second devices 103(1) and 103(2), the processor 108 may be either master devices or slave devices since they can initiate request transactions, as well as respond to request transactions from other devices. The memory 104, memory 109, and memory 107 are typically slave devices. The memory 104, memory 109, and memory 107 may be accessed directly or through memory controllers. Also, for example, the requestors from different hierarchical layers may be attached as master devices to the bus controller and the modules that provide memory responses, including responses from the other hierarchical levels, may be attached as slave devices to the bus controller, as described in more detail below.

The data width of the buses (e.g., system bus 110, engine bus 120, and device bus 130) need not be the same across all hierarchies. In one embodiment, transaction-combiner or transaction-splitter circuits can be used to connect the wider or narrower width sub-systems to the current bus controller, respectively. In one embodiment, the buses support byte, half-word, word, or double-word transactions that are aligned to the appropriate boundary. Alternatively, other bus widths may be used. A misaligned address error may be detected by the bus controller 106 using error-detection hardware as known to those of ordinary skill in the art. In another embodiment, each bus controller 106 keeps a bus status word register (BSW) which records these errors. An example configuration within one hierarchy level is illustrated and described with respect to FIG. 2. Any one of the master devices and any one of the slave devices could be viewed as an interface to the upper hierarchy level. Likewise, another pair of master and slave devices could form the interface to a lower level sub-system. Other master devices and slave devices may be local to this hierarchical level.

In one embodiment, memories 104, 109, and 107 of the system 100 may reside in two address spaces: a global address space and a local address space. The local address space is private between a master device and a local memory on a P2P connection. Each of the local address spaces start at zero and continue up to the size of the particular memory. A resource arbiter of the bus controller 106 may be configured to only handle the local address spaces for P2P connections. The global address space allows shared access to memories 104, 109, and 107 using the shared hierarchical buses. Multiple memories may appear in this global address space. The global address space is setup to ensure that all objects within a sub-system have a “unique” global address, meaning any object in the global address space appears at the same global address to each device of the system, regardless of the level of hierarchy at which the memory appears, and any object appears only once in the global address space. It is possible for a memory to appear only in the global address space if it has no P2P connection. In this case, the memory need only be single ported because there is only one shared bus that accesses the memory. Although a memory controller may be required to convert the bus protocol to SRAM signals, a non-shared memory may not use a resource arbiter 202. It is also possible for a memory to be present only on P2P connections. Such memories could be multi-ported or shared between many master devices. However, such memories may not be able to be initialized by the external host 101.

In one embodiment, when a target memory element width is not the same as the shared bus word width, the memory data may be embedded into a byte-addressable memory space where each element is aligned to the next power-of-2 boundary. For example, every element in a 19-bit wide memory would be given a unique 32-bit address, whereas a 37-bit wide memory would be given 2 word addresses for every element. It should be noted that P2P connections would not provide byte access to the memory, but only “element” accesses. In the case of the shared bus access to the 37-bit wide memory, all odd “word” addresses would interface to only five bits of actual memory.

### Shared Buses

FIG. 2 is a block diagram of one embodiment of the bus controller 106 of FIG. 1 that is coupled to multiple master devices 201(A)-201(C) and multiple slave devices 204(1)-204(4), at one hierarchical level, using shared buses 210(A) and 210(B) and direct connections 220(A)-220(C) and 220(1)-220(4). It should be noted that the direct connections 220 are used to connect device ports to the bus controller 106. The two or more direct connections 220 may be used to form a P2P bus, which denotes the entire path from a master device to a slave device, possibly through a resource arbiter. The bus controller 106, which is representative of any of the bus controllers at the different hierarchical levels, controls the buses of FIG. 1, such as engine bus 120 or device bus 130. The bus controller 106 includes a resource arbiter 202 and an address decoder 203. The bus controller 106 may include additional circuits that are not described herein, such as circuitry to perform bus-adapter-type functions, or the like. In one embodiment, the bus controller 106 can be implemented to include separate request and response arbiters 202(A) and 202(B), respectively, and the address decoder 203. At any cycle, the incoming requests (also referred herein as request transactions) from various master devices 201(A)-201(C) are arbitrated, then the arbitrated request (e.g., winning master's request) is decoded by the address decoder 203, and forwarded to the appropriate slave device (e.g., slave devices 204(1)-204(4)). When the response is ready, the slave device generates a response (also referred herein as a response transaction) back to the requesting master device. The request bus 210(A) coming out of the request arbiter 202(A) and the response bus 210(B) coming out of the response arbiter 202(B) are coupled to the shared resources. Request-response ordering information is shared between the request arbiter 202(A) and the resource arbiter 202(B) in order to maintain FIFO semantics, as described below.

In this embodiment, each of the master devices 201(A)-201(C) include an incoming response port 214 (e.g., response shared bus ports 214(A)-214(C)) and an outgoing request port 221 (e.g., request ports 221(A)-221(C)). Also, each of the slave devices 204(1)-204(4) include an incoming request port 212 (e.g., request shared bus ports 212(1)-212(4)) and an outgoing response port 223 (e.g., response ports 223(1)-223(4)). The request arbiter 202(A) of the bus controller 106 includes incoming request ports 222 (e.g., request ports 222(A)-222(C)) for each master device 201. The incoming request ports 222(A)-222(C) are coupled to the direct connections 220(A)-220(C), respectively. The request arbiter 202(A) also includes an outgoing request port 211 that is coupled to the request shared bus 210A, which is coupled to each of the slave devices 204(1)-204(4). The response arbiter 202(B) of the bus controller 106 includes incoming response ports 224 (e.g., response ports 224(1)-(4)) that are coupled to each of the slave devices 204. The incoming response ports 224(1)-(4) are coupled to the direct connections 220(1)-220(4), respectively. The response arbiter 202(B) also includes an outgoing response port 213 that is coupled to the response shared bus 210B, which is coupled to each of the master devices 201(A)-201(C).

In one embodiment, the architecture of the shared bus (210(A) and 210(B)) preserves end-to-end, in-order responses even in the presence of unbalanced slave-device latencies. For example, the bus controller 106 may delay the response to a short latency transaction to one slave device that was issued after a long latency transaction to another slave device from the same master device, until after the response to the long latency transaction has been received. This may be achieved without assuming fixed latency or external data tagging, while pipelined and non-blocking transaction semantics is maintained as much as possible. The bus controller 106 is responsible for maintaining FIFO semantics for each master device 201 or slave device 204 that connects to the bus controller 106. There is exactly one shared bus path (request and response shared bus 210(A) and 210(B)) from a requestor (e.g., master device 201(A)) to a responder (e.g., slave device 204(1)) in a tree which ensures that no two requests between the same pair of nodes (e.g., master device 201(A) and slave device 204(1)) can get out of order. It should be noted, however, that the path from a requestor (e.g., master device) to a responder (e.g., slave device) may end in a resource arbiter 202 that shares memory resource between the shared buses 210(A) and 210(B) and the various direct connections 220(A)-(C) and 220(1)-(4). The resource arbiter 202 achieves FIFO ordering by returning the responses generated by one or more slave devices for the same master device in the same order as they were requested by that master device. It also expects that each slave device returns the responses for the requests generated by one or more master devices in the same order as they were issued to that slave device. This ensures that FIFO ordering is maintained on each master or slave link connected to the bus controller. The end-to-end FIFO ordering may then be achieved as a composition over multiple data path links from a requestor (e.g., master device 201) to a responder (e.g., slave device 204) within the system's tree structure.

The request transactions from various master devices 201(A)-201(C) in the bus controller 106 are arbitrated on a priority basis with the highest priority always given to an external master's incoming link. In one embodiment, one of the request port 222(A)-222(C) that is coupled to an external master device is given higher priority over the other request ports. The remaining local ports are prioritized on an equal-priority basis or a full-priority basis. Alternatively, the remaining ports may be prioritized using other prioritizing techniques known to those of ordinary skill in the art. Giving one port the highest priority over the other ports may guarantee that a local master device within a sub-system does not starve the global system, which includes the sub-system. As such, the external master device may generate as many request transactions to the sub-system without the requests being deadlocked. In one embodiment, external requests, when present, get priority over the local requests, and the local requests are prioritized with respect to one another in a FIFO manner. It should be noted that only the external master device needs to have a higher priority over all other local master devices, which can themselves be configured with any static or dynamic (e.g. round-robin) priority scheme as known to those of ordinary skill in the art.

In one embodiment, the bus controller 106 supports prioritized, non-blocking transactions. To support prioritized, non-blocking transactions means that a high priority master device is allowed to connect to an available slave device even if a lower priority request is blocked. The high priority master device may be allowed to connect to the available slave device because the request and response paths are independently arbitrated. A master device waiting for a slave-device response does not block either the request bus 210(A) or the response bus 210(B). The property of supporting prioritized, non-blocking transactions may increase throughput of the system and may ensure deadlock-free execution when two master/slave devices residing in different sub-systems within the system hierarchy make simultaneous global requests to each other (i.e., a first device sending a request to a second device, while the second device is sending a request to the first device). For example, each request is first arbitrated locally (low priority) and then routed through the outgoing slave-device link of the local sub-system into the incoming master-device link of the remote sub-system (high priority). The incoming master-device request is satisfied even when a lower priority transaction is outstanding in each sub-system.

### P2P Buses

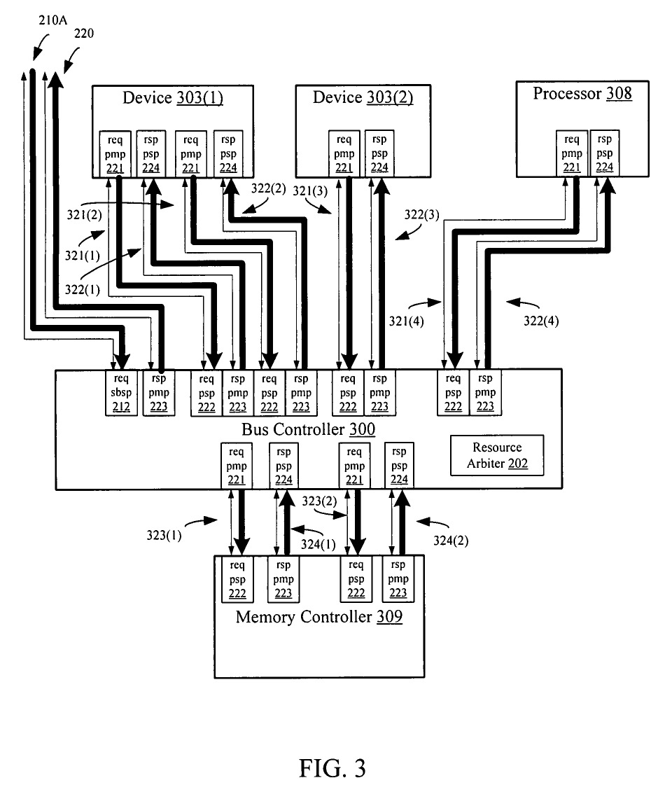

In one embodiment, the application engine 102 of FIG. 1 also uses direct P2P connections between requesters (master devices) and responders (slave devices) in order to achieve the bandwidth required to meet the desired system performance. There can be many independent P2P connections at any hierarchy level. One hierarchy level is illustrated in FIG. 3.

FIG. 3 is a block diagram of one embodiment of a bus controller 300 that is coupled to multiple devices and the memory controller 309, at one hierarchical level, using P2P buses. The multiple devices in this embodiment include a first device 303(1), a second device 303(2), and a processor 308, that are each coupled to the bus controller 300 via direct connections. In particular, the first device 303(1) includes four ports; two request ports 221 and two response ports 224 that are coupled to request P2P buses 321(1) and 321(2) and to response P2P buses 322(1) and 322(2), respectively. The direct connections 321(1) and 321(2) are coupled to two request ports 222 of the bus controller 300. The direct connections 322(1) and 322(2) are coupled to two response ports 223 of the bus controller 300. Similarly, the second device 303(2) includes two ports, a request port 221, and a response port 224 that are coupled to a direct connection 321(3) and to a direct connection 322(3), respectively. The direct connection 321(3) is coupled to a request port 222 of the bus controller 300, and the direct connection 322(3) is coupled to a response port 223 of the bus controller 300. The processor 308 also includes two ports; a request port 221 and a response port 224 that are coupled to a direct connection 321(4) and to a direct connection 322(4), respectively. The direct connection 321(4) is coupled to a request port 222 of the bus controller 300, and the direct connection 322(4) is coupled to a response port 223 of the bus controller 300.

The memory controller 309 includes four ports; two request ports 222 and two response ports 223 that are coupled to direct connections 323(1) and 323(2) and to the direction connections 324(1) and 324(2), respectively. The direct connections 323(1) and 323(2) are coupled to two request ports 221 of the bus controller 300. The direct connections 324(1) and 324(2) are coupled to two response ports 224 of the bus controller 300. These ports and connections provide end-to-end P2P bus interconnects between the devices 303(1), 303(2), processor 308 and the memory controller 309 through the bus controller 300. It should be noted that the bus controller 300 also includes two ports that support the shared bus interconnect; the requests shared bus 210A and the response shared bus 210B. One of the two ports is the request shared bus port 212, which is coupled to the request shared bus 210A, and the other of the two ports is the response port 223, which is coupled to a direct connection 220, as described above with respect to FIG. 2. It should also be noted that the bus controller 300 uses the request shared bus port 212 to receive external requests from an external master device, and the direct connection 220 to respond to an external device. For example, a shared bus request is received at the request shared bus port 212 and the bus controller 300 arbitrates the transaction and sends the request to the memory controller 909 on the direct connection 323(1). The bus controller receives the corresponding response transaction from the memory controller 309 on the direct connection 324(1) and arbitrates the response transactions and sends the response to the external master device on the direct connection 220.

In this embodiment, the requesting master device is the first device 303(1), the second device 303(2), or the processor 308, and the responding slave device is the memory controller 309, which is coupled to a memory (not illustrated). In this embodiment, the P2P transactions go through bus controller 300, including a resource arbiter 202, since the memory (via the memory controller 309) is shared across many such P2P or shared bus connections (e.g., request shared bus 210A and direct connections 321(1)-(4)). In one embodiment, the resource arbiter 202 includes a request arbiter and a response arbiter to separately handle the request and response transactions. Alternatively, the resource arbiter 202 handles both the request and response transactions. In one embodiment, the width of the data bus in a P2P connection is set according to the width of the elements in the memory. In one embodiment, the addressing in a P2P connection is “element-wise,” meaning a zero-based element index is provided as the address, regardless of the element width.

In this embodiment, the memory controller 309 is a dual-ported memory controller. In this embodiment, the highest priority port is the request shared bus port 212. That is, the bus transactions received from an external master device on the shared bus 210A takes priority over the local master devices (e.g., 303(1), 303(2), and 308).

In one embodiment, the bus controller 300 is configured to differentiate between P2P bus transactions from P2P bus requestors and shared bus transactions from shared bus requesters by determining whether the received transaction is on a port connected to a shared bus or a P2P bus. In this embodiment, the bus controller 300 converts the global shared address received on the shared bus port into a local device address similar to the one received on the P2P bus ports. In one embodiment, this conversion is made simply by masking higher-order address bits representing the base address of this device in the global address space and by aligning the remaining bits from a “byte-address” to an “element address” based on the data width of the device. In another embodiment, a more complex mapping from global to local addresses may be used such as hashing. In one embodiment, the bus controller 300 does not need to differentiate between P2P bus transactions from P2P bus requesters and shared bus transactions from shared bus requesters after conversion of global shared address to a local device address because the slave memory space is properly embedded into the global system address space with aligned element addresses. When the element width is wider than a word on shared bus (e.g., a shared bus transaction is wider than the bus width of the shared bus), a transaction-combiner circuit (not illustrated) is added between the shared bus and the resource arbiter 202, which translates the “byte-addressed” narrow shared bus into the “element-addressed” wide P2P connection. When the element width is narrower than a word on shared bus (e.g., a shared bus transaction is narrower than the bus width of the shared bus), either transactions wider than the element width (e.g., rounded to power-of-2) may be disallowed, or a transaction-splitter circuit (not illustrated) may be added between the shared bus and the resource arbiter 202, which translates the wide transactions on the shared bus to multiple element transactions. It should be noted that transaction-combiner and transaction-splitter circuits are known to those of ordinary skill in the art, and accordingly, a detailed description regarding the transaction-combiner and transaction-splitter circuits has not been included.

In one embodiment, the resource arbiter 202 that receive P2P connections is aware that inputs may not all come from independent stall domains. For example, two requests may originate from the first device 303(1), and therefore, both requests of the first device 303(1) are in the same stall domain. It should be noted that if the resource arbiter 202 is not aware, the resource arbiter 202 potentially could become deadlocked when simultaneous multiple requests are made to the same resource (e.g., memory controller 309) from the same or codependent stall domains. This is because the arbitrated requests may result in responses coming back in sequence; however the two master devices may need to see simultaneous responses in order to come out of a stall.

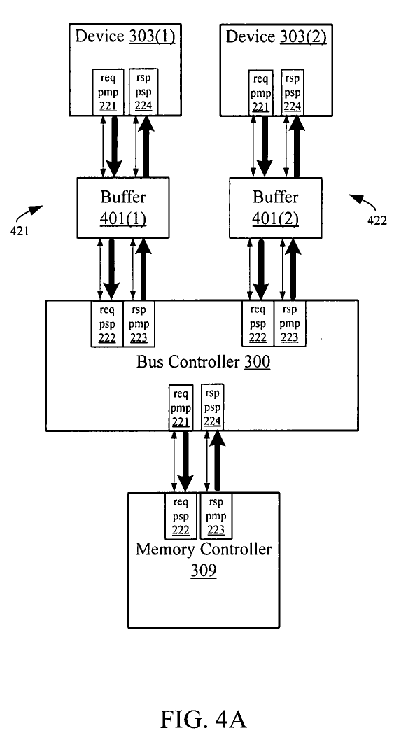

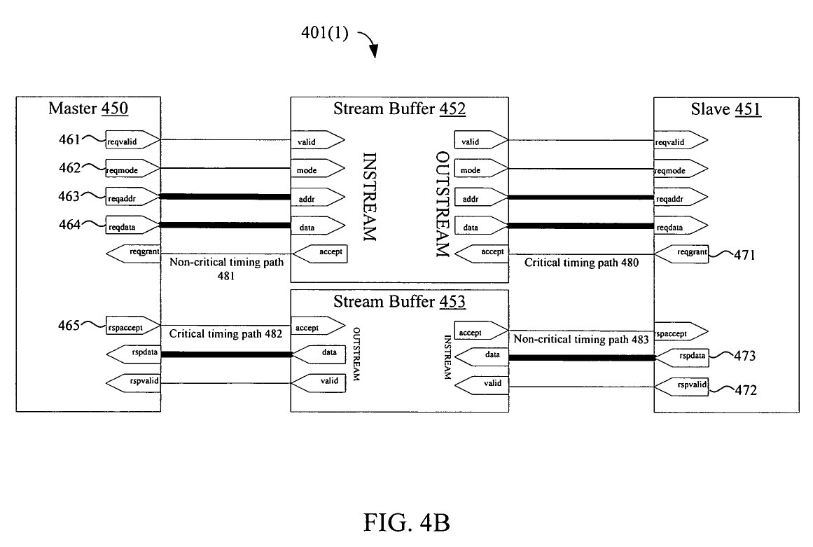

In one embodiment, a stream buffer 401, as illustrated in FIG. 4A, is added to each master device's response path to allow the responses to be delivered one-by-one without blocking the resource arbiter 202. In the embodiment of FIG. 4A, a first buffer 401(1) is added in the bus 421 (e.g., request P2P bus 321(1) and response P2P bus 322(1)) between the request port 221 of the first device 303(1) and the request port 222 of the bus controller 300, and a second buffer 401(2) is added in the bus 422 (e.g., request P2P bus 321(3) and response P2P bus 322(3)) between the request port 221 of the second device 303(2) and the request port 222 of the bus controller 300. It should be noted that in this embodiment, the resource arbiter 202 of the bus controller 300 has a round-robin arbitration and the response buffering by the buffers 401(1) and 401(2) at the master devices (e.g., devices 303(1) and 303(2)) allows the resource (e.g., memory controller 309) to be used at full throughput even if the master devices are not able to accept the response from the memory controller 309 immediately. In one embodiment, the buffers 401(1) and 401(2) are stream buffers. Alternatively, other types of buffers may be used.

Multi-ported resource arbitration, such as the dual-ported resource arbitration by the resource arbiter 202 may be a generalization of the single ported model. In one embodiment, for full bandwidth utilization, the resource arbiter 202 internally contains as many arbitration and data transfer paths as there are resource ports. However, some constraints may be placed on connectivity to control the complexity of the hardware design. The bus architecture, as set forth in the described embodiments, does not place any restrictions or requirements on such arbiter designs as long as the end-to-end ordering protocol (e.g., FIFO semantics) is being followed. Since the bus controller supports the flexible bus protocol as described herein, each of the resource ports is considered to be an independent endpoint.

In one embodiment, in order to maintain modularity and promote component reuse in a bottom-up design hierarchy, P2P connections are allowed to cross hierarchies only in one direction—inside-out. This means that a shared memory, which is accessed with a direct P2P connection from several devices, is allocated at the lowest common ancestor of the accessing devices. This structural property implies that each of the accessing devices can be designed in isolation without worrying about the arbitration and path to the shared memory. In turn, the shared memory and the associated interconnect may be generated when the enclosing sub-system is designed in a bottom-up manner.

In another embodiment, a sub-system architecture allocates the memories within a sub-system that are “owned” by that sub-system, even if the memories are accessed and shared with devices outside the sub-system. In this embodiment, an additional outside-in access port can be provided for each externally visible resource. This organization of this embodiment has the additional property of providing low-latency local access to the sub-system where the memory is owned, and potentially longer latency accesses to the external devices that access the memory of the sub-system from outside the sub-system. It should be noted that the bus controller 300 and the corresponding flexible bus protocol can be implemented in either configurations described above.

### Transaction Protocols

In one embodiment, the P2P connections support burst transactions in a circuit switched manner. Once a burst transaction has been granted access, the burst transaction continues to get access until the burst transaction completes. The operations of the burst transaction are described in more detail below.

FIG. 4B is a block diagram of one embodiment of a master device 450 coupled to a slave device 451 using stream buffers 452 and 453. As described above, the stream buffers 452 and 453 can be added each to the response path to allow the responses to be delivered one-by-one without blocking the resource arbiter 202. In one embodiment, the master device 450 is the first device 303(1), the second devices 303(2), or the processor 308, and the slave device 451 is the bus controller 300. In another embodiment, the master device 450 is the bus controller 300 and the slave device 451 is the memory controller 309, as illustrated in FIG. 3. Alternatively, the master device 450 and slave device 451 may be other types of devices in the system, such as, for example, a memory, a memory controller, or the like.

In the embodiment of FIG. 4B, the flexible bus protocol is used on the shared bus and the P2P connections, and implements a two-way handshake on both the request and response paths between master and slave devices. The flexible bus protocol includes multiple signals that are sent between the master and slave devices, such as the exemplary signals described below in Table 1-1. In one embodiment, there are five request signals and three response signals sent between the master device 450 and the slave device 451. The five request signals are 1) a request valid signal 461, 2) a request mode signal 462, 3) a request address signal 463, 4) a request data signal 464, and 5) a request grant signal 471.

TABLE 1-1

| | | Master | | Slave | | |
|---|---|---|---|---|---|---|
| Signal | Timing | Bits | Dir | Bits | Dir | Description |
| reqvalid 461 | early | 1 | O | 1 | I | Request Valid |
| reqmode 462 | early | 5 | O | 5 | I | Request Mode |
| reqaddr 463 | early | A | O | A | I | Request Address |
| reqdata 464 | early | D | O | D | I | Request Data |
| reqgrant 471 | Mid- | 1 | I | 1 | O | Request Grant |
| | cylce-to- | | | | | |
| | late | | | | | |
| rspvalid 472 | early | 1 | I | 1 | O | Response Data Valid |
| rspdata 473 | early | D | I | D | O | Response Data |
| rspaccept | Mid- | 1 | O | 1 | I | Response Accept |
| 465 | cylce-to- | | | | | |
| | late | | | | | |

The request valid signal (reqvalid) 461 indicates that a request transaction on the bus is valid. The request mode signal (reqmode) 462 indicates a mode, a size, and/or a type of transaction for the request transaction. The request address signal (reqmode) 463 includes a transaction address of the request transaction. The request data signal (reqdata) 464 includes request data of the transaction request. The request data signal 464 is sent to the responding slave device 451 for write and exchange operations. The request grant signal (reqgrant) 471 indicates that the request transaction is granted access by the slave device 451. The request grant signal 471 is sent back from the slave device 451 to a requesting master device 450 to indicate that the master device 450 has been granted access. It should be noted that the master device 450 may have to hold their requests across many cycles until they are granted access. The three response signals are 1) a response accept signal 465, 2) a response valid signal 472, and 3) a response data signal 473. The response accept signal (rspaccept) 465 indicates that the master device 450 has accepted a response transaction from the slave device. The slave device 451 may have to hold their responses across many cycles until their response is accepted. The response valid signal (rspvalid) 472 indicates that the response transaction on the bus is valid. The response data signal (rspdata) 473 includes response data of the response transaction. The response data signal 473 is sent to the requesting master device 450 for read and exchange operations. For P2P connections, the bus width may be only be as wide as the data width of the transaction. For shared bus connections, the bus width may be a bus width of a power-of-2 defined at the system design time (e.g., 32 bits).

In one embodiment, the request valid signal 461, request mode signal 462, request address signal 463, request data signal 464, response valid signal 472, and the response data signal 473 are designated as early signals, and the request grant signal 471 and the response accept signal 465 are designated as mid-cycle-to-late signals. The designation of an early signal indicates that the signal is received towards the beginning of the cycle, while the mid-cycle-to-late signal indicates that the signal is received at the middle of the cycle or towards the end of the cycle. In one embodiment, the early signal is an input signal that is received before a time of the cycle that is less than approximately 40% of the cycle time, and the mid-cycle-to-late signal may be an input signal that is received after the time of the cycle that is more than approximately 40% of the cycle time. Alternatively, the early signals and the mid-cycle-to-late signals may be other values. In another embodiment, the request grant signal 471 and the response accept signal 465 are mid-cycle signals. In another embodiment, the request grant signal 471 and the response accept signal 465 are late signals. It should be noted that the request grant signal 471 and the response accept signals 465 may arrive later than the other signals due to being processed by more computational logic than the other signals. Alternatively, the request signals and response signals may be designated in other combinations that are consistent with respect to the embodiment of Table 1-1.

The request mode signal 462 may include information regarding the width of the transactions. In one embodiment, the flexible bus protocol supports different transaction widths. For example, the data memory for the processor 308 is a “byte-addressable” memory defined to support char, short, int and long long C data types. These map to byte, half-word, word, and double-word transaction sizes, respectively. The instruction memory of the processor 308 is “quanta-addressable” memory defined to support quantum and packet data types. A packet consists of power-of-2 number of quanta. Quantum width may be specified at design time. A local memory device is an “element-addressable” memory defined to support data elements that could have an arbitrary non power-of-2 element width. Alternatively, the flexible bus protocol may be configured to support transactions of similar widths.

The request mode signal 462 may also include information regarding the type of the transactions. In one embodiment, the flexible bus protocol supports different transaction types, such as write (store) transactions, read (load) transactions, exchange transactions, or the like. The exchange transaction may perform a read and then a write to the same address.

Table 1-2 describes an exemplary encoding of the mode bits for the request mode signal 461 according to one embodiment. Alternatively, other encodings than the exemplary encoding of Table 1-2 are also possible.

TABLE 1-2

| [4] | Burst-Mode | | | | | |
|---|---|---|---|---|---|---|
| | | | | | | transaction |
| | [3] | [2] | transaction size | [1] | [0] | type |
| 0 | 0 | 0 | Byte | 0 | 0 | reserved |
| | 0 | 1 | half-word | 0 | 1 | read (load) |
| | 1 | 0 | word/quanta/element | 1 | 0 | write (store) |
| | 1 | 1 | double-word/packet | 1 | 1 | Exchange |

| | [3] | valid | [2] | transaction size | [1] | type | [0] | extent |
|---|---|---|---|---|---|---|---|---|
| 1 | 1 | V | 0 | word/quanta/element | 0 | read | 0 | CNT |
| | | | | | | (load) | | |
| | 1 | V | 1 | double-word/packet | 1 | write | 1 | EOT |
| | | | | | | (store) | | |
| | 0 | D | | | | | | |

bit[3]: valid - used to indicate a valid (1) or a dummy transaction (0).
bit[2]: size - only word & double-word transaction sizes are supported.
bit[1]: type - only read & write transaction types are supported.
bit[0]: extent - used to indicate that this is a continuation/final request.

The request mode signal 462 may include one or more bits to indicate a mode, such as a normal transfer mode and a burst transfer mode, one or more bits to indicate a transaction size, and one or more bits to indicate a transaction type. The request mode signal 462 may also include one or more bits to indicate whether the transaction is a valid transaction or a dummy transaction. The dummy transaction may be used to setup a burst transaction, as described below. The request mode signal 462 may also include one or more bits to indicate whether the transaction is a continued transaction in the burst transfer mode or an end-of-transfer (EOT) request in the burst transfer mode. The one or more bits used to indicate the size of the transaction may indicate that only word or double-word transaction sizes are supported in the burst transfer mode. Similarly, the one or more bits used to indicate the transaction type may indicate that only read and write transactions types are supported in the burst transfer mode. Alternatively, the encodings may indicate other sizes and/or types of transactions that are supported.

Burst transactions may be supported by the flexible bus protocol, which is implemented in multiple bus controllers, by sending a burst request from a requesting master device to a responding slave device across multiple bus hierarchies. Each arbiter of the multiple bus controllers that are involved in routing a burst transaction performs a circuit-switch and does not change their grant selection (e.g., request grant signal 471) until the final transfer in the burst has been handled. In the burst transfer mode, every request indicates whether it continues or ends the burst transfer using the extents CNT for continuing the burst transfer mode and EOT for ending the burst transfer mode. The routing arbiter of each of the bus controllers releases the grant selection upon processing the final request.

It should be noted that the burst transfer mode may take a few cycles for the circuit switch to get established fully on the first transaction. In another embodiment, the burst transfer mode may use a dummy request at the beginning to establish the circuit switch. The endpoint, such as the slave device (e.g., memory controller 309) responds to the dummy burst request of the requesting master to signify the setup of an end-to-end path. Once the requesting master receives the dummy setup response from the slave device, the requesting master starts the actual burst. In another embodiment, the end of the burst may be signaled using a dummy request as well. This way the mode bits need not be changed at all during the valid data portion of the burst. In another embodiment, the burst request is sent in the first transaction of the burst transfer, and the EOT is in the last transaction of the burst transfer.

As described above, the flexible bus protocol is defined to work with different address widths using the request address signal 463. For P2P connections, the address bus needs to be only as wide as the address bus of the target device to which it is connected. For example, the address bus width is equal to the width of the address port of memory. In one embodiment, the address bus width is determined using the following equation (1).

Bus width=ceil(log₂ #mem-elements) bits wide. (1),

where #mem-elements is representative of the number of memory elements in the memory, and where ceil is a ceiling function that converts real numbers to close integer values, in particular, the smallest integer not less than the value of the real number. This equation represents the minimum number of bits needed to address the memory with a given number of elements. The address bus width for P2P connections needs to be only as wide as the address space of a target device because the P2P connections are element-addressed starting from zero. For shared bus connection, the address bus width may be fixed at system definition time (e.g., 32 bits) because every memory on the shared bus is mapped to a single, global byte-addressable space. All master devices put out the full-byte address on the shared bus and the transaction is routed to local or global targets based on the address decoding of the full-byte address.

As mentioned above, the flexible bus protocol is defined to work with different transaction widths on the request data signal 464. For P2P connections, the bus may be as wide as the data width of the target to which the bus is connected. For shared bus connections, the data bus width may be a power-of-2, which may be defined at system design time (e.g., 32 bits). As an example of different data width connections, the processor's 308 instruction memory interface may be defined in terms of quanta and packets using a P2P connection. A quanta is some arbitrary number of bits (e.g., 8, 9, 13, or the like) that is not limited to be a power-of-2 and which represents the smallest atomic portion of instruction memory that can be read and/or written. A packet contains some power-of-2 quanta and represents the instruction fetch width. For shared bus connections, the quanta and packets of the instruction memory are mapped to a byte and word addressed space so that it can be accessed uniformly by external devices. The processor's 308 instruction memory may initially be loaded by a host (e.g., host 101), such as a SoC host processor performing a sequence of word writes to that memory (e.g., memory 107).

As another example, the device 103(2) may have a non-power-of-2 width for its local memory 107. For P2P access, only element-wide transactions may be allowed so the data bus width is the exact element width of the memory. For shared bus access, if the memory element width is smaller than the bus width of the shared bus, then the shared bus data may be trimmed down to the element width. If the memory element width is larger than the shared bus data bus width, then either the memory should be byte-enabled to allow partial width transactions or a transaction-combiner circuit may be used to convert to the full element-wide data bus of the memory.

It should be noted that the request grant signal 471 may be dependent on the request valid signal 461. Potentially, there may be many transactions that have to be arbitrated by the bus controller 300 for transactions on the shared bus; however, in a P2P configuration without arbitration, a slave device may assert this signal independently to indicate that it is ready to accept a request. In either case, the request transaction is considered to have taken place only when both the request valid signal 461 and the request grant signal 471 are asserted.

In one embodiment, the request grant signal 471 has a critical timing path. In one embodiment, physically, there is only 20% of each cycle in which the request grant signal 471 may be received. For example, there are about 8 typical gate delays in a 0.13 μm process at 250 MHz. As described herein, in order to solve these critical timing problems, the bus architecture can automatically insert buffers, such as stream buffers 452 and 453, into the request path. In one embodiment, the stream buffers are inserted closer to the responding device than the requesting device. The addition of stream buffers on the request and/or response paths may have the effect of increasing the physical latency of the operation. Since these buffers may be automatically inserted in the bus architecture during the design process, the software tool-chain can be informed of the realized latency to schedule instructions appropriately when being compiled. Alternatively, the tool-chain may assume a fixed architectural latency and any additional latency may be realized as a stall cycle back to the requesting master device 450.

In the embodiment of FIG. 4B, stream buffer 452 is placed between the master device 450 and the slave device 451 to provide insulation for the request and response signals described above. For example, when the request grant signal 471 is sent from the slave device 451 to the stream buffer 452 it is considered a critical timing path 480; however, using the stream buffer 452, when the request grant signal 471 is sent from the stream buffer 452 to the master device 450, it is no longer a critical timing path (e.g., non-critical timing path 481), providing timing insulation for critical timing paths. It should be noted that in other embodiments, no stream buffers are provided between the master device 450 and slave device 451.

It should also be noted that the response accept signal 465 may be dependent on the response valid signal 472. Potentially, there may be many transactions that have to be arbitrated by the bus controller 300 for transactions on the shared bus in a system with multiple levels of arbitration (e.g., the response accept signal 465 may be contingent upon having the response accepted at other levels); however, in a P2P configuration without arbitration, a master device may assert this signal independently to indicate that it is ready to accept a response. In either case, the response transaction is considered to have taken place only when both the response valid signal 472 and the response accept signal 465 are asserted. Like the request side, the response accept signal 465 may also have a critical timing path when connected via a multi-slave response arbiter. Stream buffers, such as stream buffer 453, may be inserted on the response path to solve this timing problem as well. For example, when the response accept signal 465 is sent from the master device 450 to the stream buffer 453 it is considered a critical timing path 482; however, using the stream buffer 453, when the response accept signal 465 is sent from the stream buffer 453 to the slave device 451, it is no longer a critical timing path (e.g., non-critical timing path 483), providing timing insulation for critical timing paths.

In one embodiment, the flexible bus protocol allows pipelined transactions, such as read and write transactions, with in-order sequential semantics even when the actual transactions take variable number of cycles to complete. The semantics of transactions between a pair of a requestor and a responder (e.g., master-slave pair) may be fixed according to the request sequence. For example, a pipelined load operation preceding a pipelined store operation to the same address gets the data before the data is updated with new data in the store operation, whereas a pipelined load operation following a pipelined store operation to the same address receives the new data even if the transactions are stalled for some reason.

### Transaction Timing

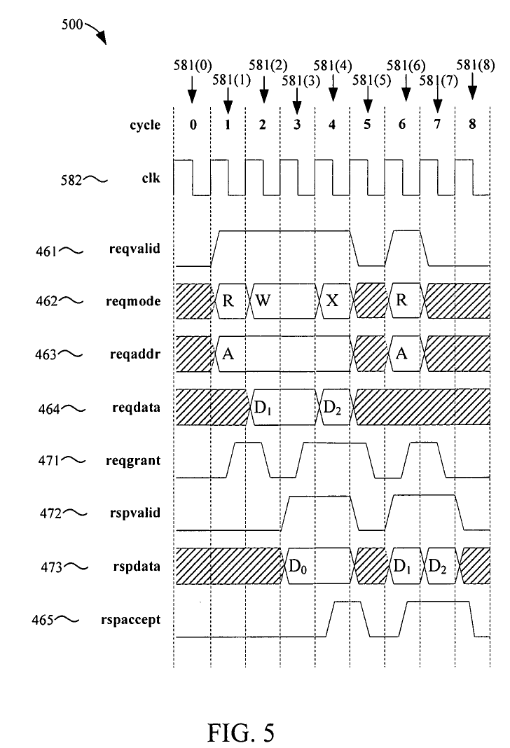

FIG. 5 is a timing diagram 500 of pipelined bus transactions between a master device and a slave device according to one embodiment of the invention. The timing diagram 500 includes a clock signal 582 to which the request and response signals are synchronized. During cycle 581(0), nothing happens. During the first cycle 581(1), a read request is made to address A, which is granted immediately, and the address A originally contains data D₀. During the second cycle 581(2), a pipelined write request is made to the same address A with data D₁. This is not granted in this cycle (i.e., the request grant signal 471 is not asserted). The requesting master device 450 decides to hold the data and the address in the next cycle; the third cycle 581(3). During the third cycle 581(3), the write request of the previous cycle is granted (i.e., the request grant signal 471 is asserted. Meanwhile, during the third cycle 581(3), the response data D₀ of the first read is returned, but the requesting master device 450 is not ready to accept the response. During the fourth cycle 581(4), a new exchange request is made to the same address A with data D₂. Due to in-order semantics, it is guaranteed that the previous write would have finished when the exchange happens. Meanwhile the read response is accepted. During the fifth cycle 581(5), nothing happens, since the request valid signal 461 and the response valid signal 472 are de-asserted. During the sixth cycle 581(6), a new read request is made to the same address A which is granted immediately. Meanwhile, the response of the previous exchange transaction is returned with data D₁, which is accepted. During the seventh cycle 581(7), the response of the last read is returned, with the response data D₂, which is the value written by the exchange transaction. The response is also accepted. During the eighth cycle 581(8), nothing happens.

In particular, during the first cycle 581(1), the request valid signal 461 is asserted, the request mode signal 462 indicates a read transaction as the transaction type, and the request address signal 463 includes the address A. During the second cycle 581(2), the request valid signal 461 remains asserted, the request mode signal 462 indicates a write transaction as the transaction type, and the request address signal 463 remains the same, address A. During the third cycle 581(3), the request valid signal 461 remains asserted, the request mode signal 462 indicates the write transaction, the request address 463 remains the same, address A, and the response valid signal 472 is asserted. During the fourth cycle 581(4), the request valid signal 461 remains asserted, the request mode signal 462 indicates the exchange transaction as the transaction type, the request address 463 remains the same, address A, the response valid signal 472 remains the same, and the response accepted signal 464 is asserted to accept the read response. During the fifth cycle 581(5), nothing happens, since the request valid signal 461 and the response valid signal 472 are de-asserted. During the sixth cycle 581(6), the request valid signal 461 is asserted, the request mode signal 462 indicates a read transaction, the request address signal 463 includes the address A, the request grant signal 471 is asserted, the response valid signal 472 is asserted, the response data signal 473 contains the data D₁, and the response accept signal 465 is asserted. During the seventh cycle 581(7), the request valid signal is de-asserted, the request grant signal 471 is asserted, the response valid signal 472 remains the same, the response data 473 includes the response data D₂, and the response accept signal 465 remains asserted.

It should be noted that although the request and response signals of FIG. 5 are synchronous with a single clock signal 582 shared between all devices attached to the bus, alternatively, the flexible bus protocol can be adapted to provide clock domain crossings and standardized interfaces using a simple bus adapter as known to those of ordinary skill in the art. It should also be noted that the latency of the transactions depends on the contention on the bus as well as local acceptance of the handshake. However, the order of requests matches the order of responses. Write transactions are not acknowledged but are still kept in order with respect to the requests made before and after it. Note that if a request is removed before it is granted, it is not considered for ordering relationship.

### Operational Flow of Bus Controller

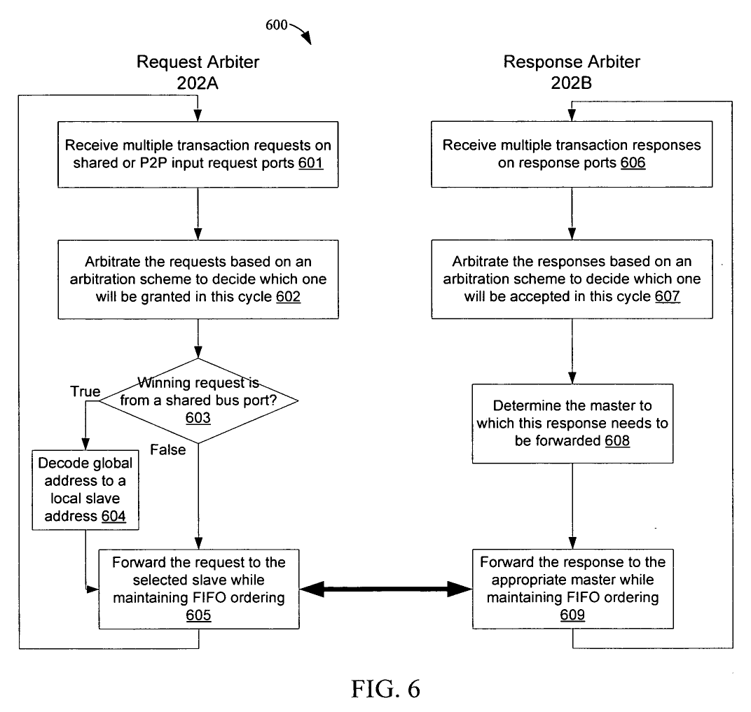

FIG. 6 is a flow chart of one embodiment of a method 600 of operating a bus controller 300 according to a flexible bus protocol that handles pipelined, variable latency transactions with point-to-point FIFO ordering between a pair of requesting and responding devices, without blocking transactions between other pairs of requesting and responding devices. The bus controller 300, as described with respect to FIG. 3, is configured to support a flexible bus protocol that handles pipelined, variable latency transactions with point-to-point FIFO ordering between a pair of requesting and responding devices on P2P connections (illustrated in FIG. 3), without blocking transactions between other pairs of requesting and responding devices received on the shared buses (e.g., request shared bus 210A illustrated in FIG. 3). In one embodiment, the bus controller 300, using the request arbiter 202A and response arbiter 202B, is configured to implement the method 600, which includes, first, receiving multiple transaction requests on shared or P2P input request ports at the request arbiter 202A, operation 601. For example, the multiple transactions may include pipelined, variable latency bus transactions between a first pair of master and slave devices on local connections, as well as a bus transaction a second pair of master and slave devices on a shared bus connection. The request arbiter 202A of the bus controller 300 arbitrates the requests based on an arbitration scheme to decide which request will be granted in this cycle, operation 602. The arbitration scheme, which is described below, may designate one of the ports (external port) to be the highest priority over the other ports (local ports). The request arbiter 202A then determines if the winning request is a shared bus port, operation 603. If the winning request is from a shared bus port, then the global address of the winning shared bus request is decoded to a local slave address, operation 604. The operation 604 may be performed by the address decoder 203. If however, the winning request is not from a shared bus port, then the request is directly forwarded to the selected slave device, based on the local slave address of the request transactions, while maintaining FIFO ordering, operation 605. After the request has been forwarded to the selected slave device in operation 605, the method returns to operation 601.

As part of the method 600, the response arbiter 202B receives multiple response transactions on response ports, operation 606. The response arbiter 202B arbitrates the responses based on the arbitration scheme to determine which response will be accepted in this cycle, operation 607. The resource arbiter 202B then determines the master device to which the accepted response needs to be forwarded, operation 608. The response arbiter 202A then forwards the response to the appropriate master while maintaining the FIFO ordering, operation 609.

In another embodiment, as part of maintaining the FIFO ordering in operations 605 and 609, the request arbiter 202A and the response arbiter 202B maintain the FIFO ordering of the multiple bus transactions between a first pair of master and slave devices, while not blocking the bus transaction between other pairs of master and slave devices.

In one embodiment, as part of processing the transactions, the bus controller 300 performs a two-way handshake for each of the request and response transactions. In one embodiment, the two-way handshake is performed by sending one or more request signals and one or more response signals as described above.

In another embodiment of the method, before the multiple transactions are received by the bus controller, a first receiving port of the bus controller 300 that is coupled to the second bus interconnect (e.g., external incoming port, which has the highest priority, is coupled to the shared bus) is prioritized as a highest priority over the other receiving ports of the bus controller 300 to avoid deadlock in arbitration of the multiple transactions. The other receiving ports of the bus controller 300 (e.g., local incoming ports coupled to P2P connections) are prioritized using an equal-priority scheme, a full-priority scheme, or other prioritizing schemes known to those of ordinary skill in the art.

In another embodiment of the method, a burst request is received as one of the transaction requests. In particular, a first-of-transfer (FOT) request is received at the bus controller to set up an end-to-end path between a master device and a slave device (e.g., first pair) that are directly or indirectly coupled to the bus controller 300 (e.g., one or more intervening bus controllers at different hierarchical levels). Then end-to-end path is a set up to be like a circuit switch that directly connects the master device to the slave device for one or more cycles. The end-to-end path is set up by maintaining a grant selection (e.g., maintaining the request grant signal 471 for that master asserted) until an end-of-transfer (EOT) request is received. After the slave device has indicate that it is ready to receive the burst data, the bus controller receives from the slave device a burst response transaction (e.g., a first-of-transfer (FOT) response) that indicates that the slave device is ready to receive the burst data. The master device, upon receiving the burst response transaction from the bus controller, sends burst data to the slave device. After the end-to-end path between the master and slave device is set up, indicated by the master device receiving the burst response transaction (e.g., first request of burst transactions or dummy request), the burst data is received from the master device in one or more data transfers in one or more cycles. Each of the data transfers of the burst data indicates whether the burst transfer continues or ends, for example, using the extents CNT for continuing the burst transfer and EOT for ending the burst transfer. Next, the bus controller receives the EOT when the burst data has been all been sent. After processing the EOT, the bus controller takes down the end-to-end path by releasing the grant selection (e.g., de-asserting the request grant signal 471). If there are other intervening bus controllers, all of the bus controllers involved in the routing of the burst transfer similarly perform a circuit switch, by holding the grant selection until the final transfer in the burst has been handled. As such, the bus controller is configured to support both a normal transfer mode and a burst transfer mode using the flexible bus protocol. It should be noted that the above described embodiment describes a burst transfer including write transactions to a slave device; however, in another embodiment, the burst transfer may include read transactions from the slave device. The burst transfers for reads and writes are set up in the same way, except the teardown occurs in opposite directions. For example, for burst transfers including read transactions, the slave device responds with the data which has the CNT or EOT which in turn triggers the teardown. Alternatively, the burst transactions may be other types of transactions, and may be set up and taken down in other configurations.

It should be noted that although the embodiments of FIG. 6 have been described with respect to the bus controller 300 of FIG. 3, these embodiments may be implemented in the bus controller 106 of FIG. 2. The bus controller 106 of FIG. 2 is configured to control shared buses only, while the bus controller 300 is configured to control shared buses as well as P2P connections. It should also be noted that some of the operations of FIG. 6 may not be performed when implemented in the bus controller 106, such as operation 603. Alternatively, other operations may be performed in the bus controller 106, such as operations described above, such as setting up a burst transfer, or the like.

### P2P Bus Timing

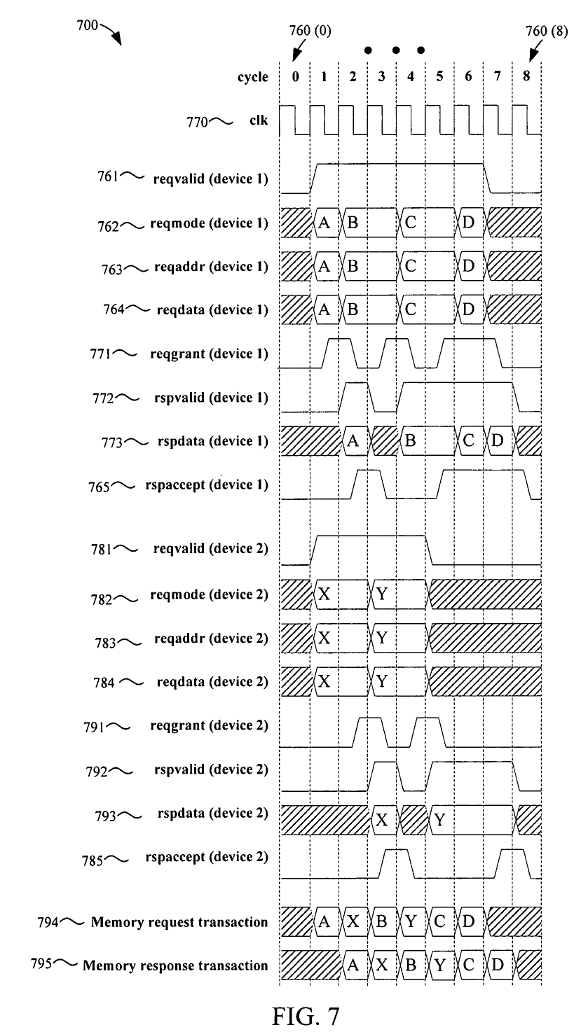

FIG. 7 is a timing diagram of pipelined bus transactions between two master devices and a slave device using P2P buses according to one embodiment of the invention. The embodiment of FIG. 7 illustrates two simultaneous read requests to a single shared resource on the same cycle using the bus controller 300 and P2P buses described with respect to FIG. 4A. The timing diagram 700 includes a clock signal 770 to which the request and response signals are synchronized. During cycle 760(0), nothing happens. During the first cycle 760(1), both the first device 303(1) and second device 303(2) each perform a read request, A and X respectively. The first device 303(1) is granted access late in the same cycle (memory request transaction 794 A). During the second cycle 760(2), the first device 303(1) makes a new request B while the second device 303(2) continues to hold the same request X from the previous cycle. Response A is available in this cycle and the first device 303(1) is ready to accept this data (memory response transaction 795 A). The resource arbiter 202 grants access to the second device 303(2) (memory request transaction 794 X). During the third cycle 760(3), the first device 303(1) continues to hold the same request B from the previous cycle while the second device 303(2) makes a new request Y. Response X is available in this cycle 760(3) and the second device 303(2) is ready to accept the data (memory response transaction 795 X). The resource arbiter 202 grants access to the first device 303(1) (memory request transaction 794 B). During the fourth cycle 760(4), the first device 303(1) makes a new request C while the second device 303(2) continues to hold the same request Y from the previous cycle. Response B is available in this cycle but the first device 303(1) is not ready to accept the data. The resource arbiter 202 transfers this response (memory response transaction 795 B) to the response buffer for the first device 303(1) until it is accepted. The resource arbiter 202 grants access to the second device 303(2) (memory request transaction 794 Y). During the fifth cycle 760(5), the first device 303(1) continues to hold the same request C from the previous cycle while the second device 303(2) stops making requests. The resource arbiter 202 grants access to the first device 303(1) (memory request transaction 794 C). Response B has been buffered (e.g., by the buffer 401(1)) into this cycle and the first device 303(1) indicates that it ready to receive the data. Response Y is available in this cycle but the second device 303(2) is not ready to accept the data. The resource arbiter 202 transfers this response (memory response transaction 795 Y) to the response buffer (e.g. to buffer 401(2)) for the second device 303(2) until it is accepted. During the sixth cycle 760(6), the first device 303(1) makes a new pipelined request D in this cycle. The resource arbiter 202 grants access to the first device 303(1) (memory request transaction 794 D). Response C (memory response transaction 795 C) becomes available in this cycle 760(6) and is accepted by the first device 303(1). Response Y has been held from the previous cycle but the second device 303(2) is still not ready to accept the data. The arbiter's 202 response buffer for the second device 303(2) continues to hold the response for yet another cycle. During the seventh cycle 760(7), there are no active requests in this cycle. Response D (memory response transaction 795 D) becomes available in this cycle and is accepted by the first device 303(1). Response Y is finally accepted by the second device 303(2) in this cycle. During the eighth cycle 760(8), nothing happens.

It should be noted that the memory returns response transactions 795 in the same order as memory receives the request transactions 794. However, since some of the response transactions are buffered in the system for a longer time than others, relatively speaking they may reach their requesting master devices at different times. This is not a problem since end-to-end request-response ordering (i.e., FIFO semantics) is still preserved. It should also be noted that the response buffers allow the resource arbiter 202 to respond to other master devices while one master device is unable to accept a response. Without these buffers there may be additional stalls incurred in the system due to responses getting backed up through the memory into the request logic.

### Shared Bus Timing

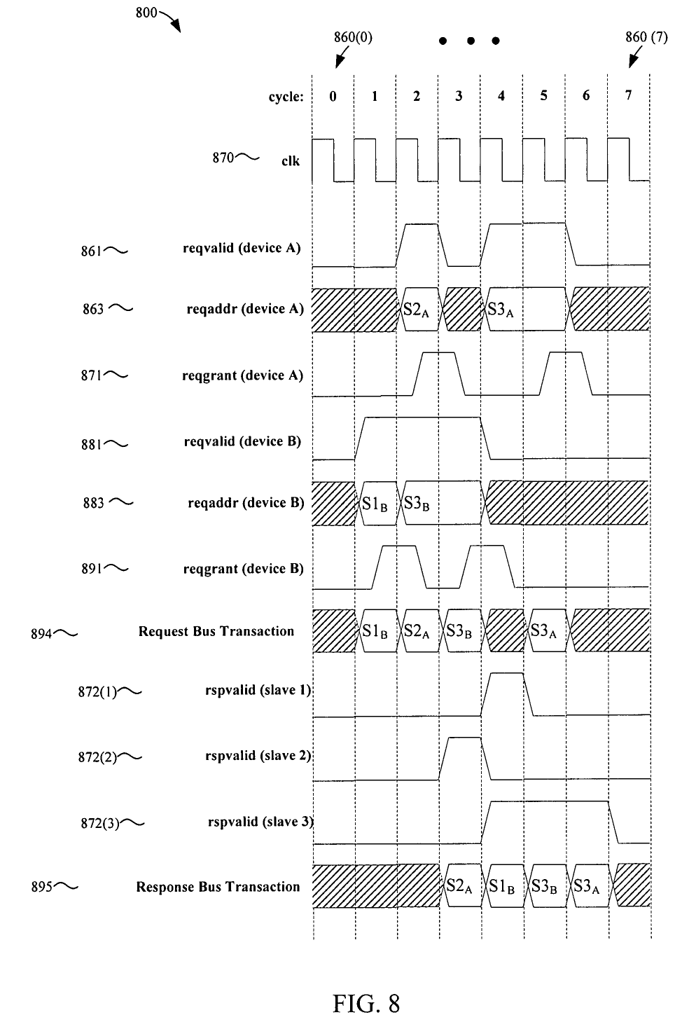

FIG. 8 is a timing diagram of pipelined bus transactions between two master devices and a slave device using a shared bus according to one embodiment of the invention. The embodiment of FIG. 7 illustrates multiple load transactions issued from two master devices to multiple slave devices using the bus controller 106 and the shared bus described with respect to FIG. 2. The timing diagram 800 includes a clock signal 870 to which the request and response signals are synchronized. In this embodiment, it is assumed that the master device 201(A) is designated to be the external incoming link, and therefore, is given the highest priority over the other local master devices 201(B) and 201(C). This ensures that local requests cannot block any global requests. Also, in this embodiment, it is assumed that the slave device 204(1) interfaces to the external outgoing link, which is buffered so that an outgoing global response that has not yet been accepted can be buffered and does not block local transactions. It should also be noted that not all signals have been illustrated in FIG. 8.

During cycle 860(0), nothing happens. During the first cycle 860(1), the local master device 201(B) makes a request to the external first slave device 204(1), which is granted (request bus transaction 894 S1_{B}), and an external request is passed on through first slave device 204(1). Since this link is buffered, the grant decision is only based on the request buffer being available to receive the request.

During the second cycle 860(2), the external master device 201(A) makes a request (reqaddr 863 S2_{A}) to the internal second slave device 204(2). Simultaneously, the local master device 201(B) makes another request (reqaddr 883 S3_{B}) to the internal third slave device 204(3). Since external master device 201(A) has higher priority, it is granted access (for the request bus transaction 894 S2_{A}), and the master device 201(B) has to hold its request. During the third cycle 860(3), the request made by the local master device 201(B) in the previous cycle is now granted (request bus transaction 894 S3_{B}). The resource arbiter 202 is configured to allow at least two outstanding requests in order for this to happen. Meanwhile, the local second slave device 204(2) is ready to respond to the external master device 201(A). The external master device 201(A) is granted access to the response bus (response bus transaction 895 S2_{A}). It should be noted that the external master device 201(A) would be granted access, even if there were other slave devices ready because the external master device 201(A) has the highest priority for responses as well. It should be noted that the external master device 201(A) was able to complete a transaction even when a local master device is still waiting for a response. During the fourth cycle 860(4), the third slave device 204(3) is ready to return the response (rspvalid 872(3)) to the master device 201(B), but due to FIFO semantics, the master device 201(B) waits first for the response (rspvalid 872(1)) from first slave device 204(1). The response (response bus transaction 895 S1_{B}) from first slave device 204(1) also arrives in this cycle (e.g., 860(4)) and is forwarded to the master device 201(B). In the same cycle 860(4), the external master device 201(A) makes another request (reqaddr 863 S3_{A}) to the internal third slave device 204(3). However, third slave device 204(3) is not ready to accept the request (reqaddr 863 S3_{A}) because it is backed up from the request (request bus transaction 894 S3_{B}) in the previous cycle from master device 201(B) whose response has not yet been accepted. It should be noted that this request may have been allowed, if the third slave device 204(3) had an extra buffer on the response path. During the fifth cycle 860(5), the third slave device 204(3) is now able to return its response (response bus transaction 895 S3_{B}) to the master device 201(B) in the same FIFO order since the earlier request (request bus transaction 894 S1_{B}) from first slave device 204(1) has been completed. The third slave device 204(3) is also able to accept the new request (request bus transaction 894 S3_{A}) from master device 201(A) in a pipelined fashion. During the sixth cycle 860(6), the third slave device 204(3) returns the response (response bus transaction 895 S3_{A}) to the master device 201(A). During the seventh cycle 860(7), nothing happens.

It should be noted that, in this embodiment, the request and response order is not exactly the same order on the shared buses. However, request-response ordering for each individual master or slave device as well as between each pair of master and slave devices is kept consistent. It should also be noted that the protocol allows pipelined transactions as well as non-blocking transactions according to the requesting priority of the devices and the amount of buffering available.

### Hierarchical Address Space Generation

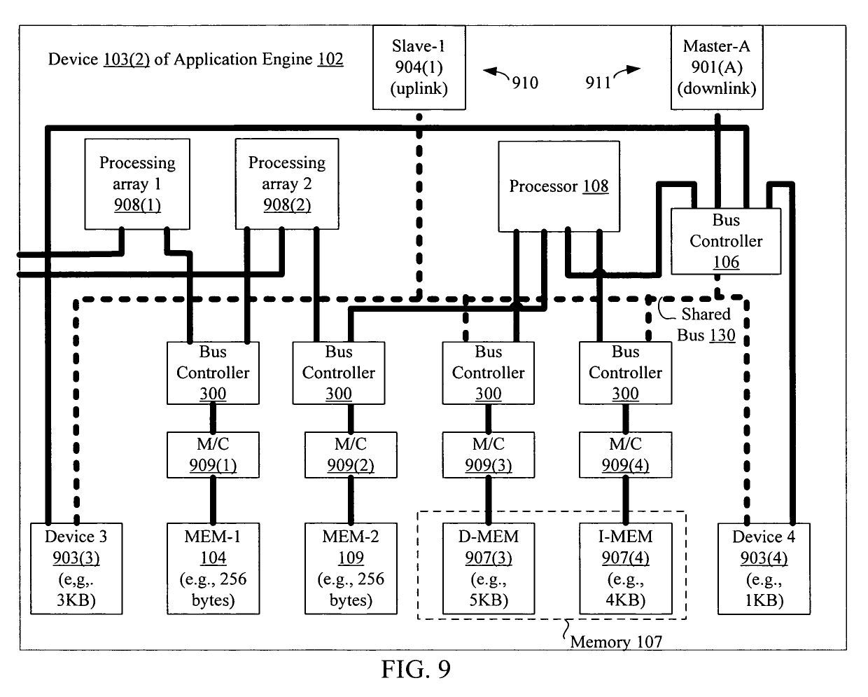

FIG. 9 is a block diagram of the internal arrangement of the second device of FIG. 1. The second device 103(2) of the application engine 102 includes a bus controller 106, multiple bus controllers 300, the processor 108, multiple memory modules 104 and 109, memory 107, a third device 903(3), a fourth device 903(4), a first processing array 908(1), and a second processing array 908(2). The bus controllers 300 are coupled to corresponding memory controllers 909(1)-909(4), respectively, and the bus controller 106. The bus controllers 300 arbitrate the transactions to the respective memory controllers 909. The bus controller 106 arbitrates transactions on the shared bus 130 (illustrated as dashed lines) between the third and fourth devices 903(3) and 903(4), the processor 108, and the downlink device 911. In one embodiment, the downlink device 911 is the master device 201(A) of the application engine 102, which has been designated as the external master device with highest priority, described with respect to FIG. 2. Alternatively, the downlink device 911 may be other devices than the master device 201(A). The first memory 104 (mem-1) and second memory 109 (mem-2) are each coupled to the corresponding memory controllers 909(1) and 909(2), respectively, and are not accessible via the shared bus 130. The memory 107 includes multiple memory modules, data memory 907(3) (D-mem), and instruction memory 907(4) (I-mem), that are each coupled to the corresponding memory controllers 909(3) and 909(4), respectively, and are accessible via the shared bus 130. The shared bus 130 is coupled between the bus controllers 300 that are coupled to the memory controllers 903(3) and 909(4), the third and fourth devices 903(3) and 903(4) and the uplink device 910. In one embodiment, the uplink device 910 is the first slave device 204(1) of the application engine 102, which is designated as the external slave device described with respect to FIG. 2. Alternatively, the uplink device 910 may be other devices than the first slave device 204(1). The remaining buses of FIG. 9 are direct connections that establish P2P connections between two devices; a master device and a slave device. In one embodiment, the external downlink master device 911 is designated as highest priority over the other local master devices. For example, when two request transactions are received during the same cycle at the bus controller 106, the first request transaction being received on the downlink device 911 takes priority over a second request transaction that is received on a local connection, such as the direct connection between the processor 108 and the bus controller 106. It should be noted that the highest priority is given only to external master devices. The responses are also resolved according to the same master device priority. In particular, the uplink device 910 is not at the highest priority because it represents local requests going out.

In this embodiment, the third and fourth devices 903(3) and 903(4) are presented on the shared bus 130. The first and second memories 104 and 109 are shared between different P2P connections, but they do not appear on the shared bus 130, and thus, do not have any global memory address. The memory 107, including the data memory 907(3) and the instruction memory 907(4) for the processor 108, connects to the shared bus, and thus, is presented in the global memory address space. In one embodiment, the global memory map at this hierarchy level is determined first to minimize the decoding hardware complexity and then to minimize the address space used. In this embodiment, first each object size is rounded up to the next power-of-2. Each object contributes its local address space (0 to power-of-2 ceiling of object size) into the global address space for allocation. Then enough bits are allocated to identify each resource attached to the shared bus using some address decoding mechanism. A common mechanism is to use variable-length address decoding, such as by the address decoder 203, because it minimizes the size of the total address space used. It should be noted that multiple copies of a resource (e.g., device, memory, processor, or the like) may co-exist and be mapped at different global base addresses. In another embodiment, the global memory map at this hierarchy level is determined to minimize the address space used as much as possible by packing the actual local address space of each object more tightly. Other mechanisms for determining the global memory map are possible that may only affect the complexity and timing of the address decoder 203.

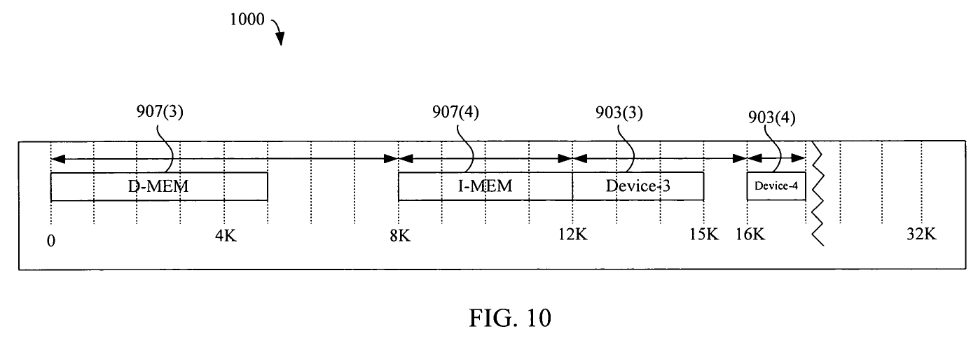

In one embodiment, the following resources are connected to the shared bus 130 and are allocated a certain amount of memory in the global address space: D-MEM 907(3) (5 KB), I-MEM 907(4) (4 KB), third device 903(3) (3 KB), and fourth device 903(4) (1 KB). The variable length decoder 203 is configured to handle: D-MEM 907(3) (8 KB) with 2 bits address code, I-MEM 907(4) (4 KB) with 3 bits address code, third device 903(3) (4 KB) with 3 bits address code, and fourth device 903(4) (1 KB) with 5 bits address code. Using variable-length address decoding these resources could be identified with 15 address bits. An exemplary encoding of the 15 address bits is described in Table 1-3 below. FIG. 10 illustrates an address mapping 1000 for multiple resources on the shared bus 130 of FIG. 9.

TABLE 1-3

| bit[14] | bit[13] | bit[12] | bit[11] | bit[10] | Mapping |
|---|---|---|---|---|---|
| 0 | 0 | addr[12] | addr[11] | addr[10] | D-MEM |
| | | | | | 907(3) |
| 0 | 1 | 0 | addr[11] | addr[10] | I-MEM |
| | | | | | 907(4) |
| 0 | 1 | 1 | addr[11] | addr[10] | Device-3 |
| | | | | | 903(4) |
| 1 | 0 | 0 | 0 | 0 | Device-4 |
| | | | | | 903(4) |

It should be noted that even though the actual memory size is only 5+4+3+1=13 KB, potentially requiring only 14 bits to encode this space, rounding up to the next power-of-2 makes it a total of 8+4+4+1=17 KB, requiring 15 bits of address space. However, rounding up to the next power-of-2 may simplify the decoding and dispatch of the transactions using simple address bit checks as shown in the variable length decoding table 1-3 given above. The memory controller or the responding device may generate an out-of-bounds error when the request falls into an address “hole”, which are addresses where no device is mapped. All such errors are registered with the bus status word register (BSW) of the bus controller 106 at the same hierarchy level of device 103(2) of FIG. 1.

In one embodiment, all bus controllers 106 are parameterized to indicate their internal address mask size. In the case of the bus controllers 106 for the device 103(2) the value of “15” is passed in that parameter to round up the address space of the device 103(2) to 32 KB. The bus controller 106 is also configured with the unique base address of the sub-system (e.g., device 103(2)) in the global, shared address space. When the bus controller 106 of the device 103(2) receives a memory request, the bus controller 106 compares the upper bits of that address outside the mask with its own base address. If these bits are the same then this request is deemed to be an internal request and is decoded internally. If the upper bits are not equal, then the request is passed up to the bus arbiter of the bus controller at the next upper level of hierarchy, for example, the bus controller 106 of the application engine 102, illustrated in FIG. 1.

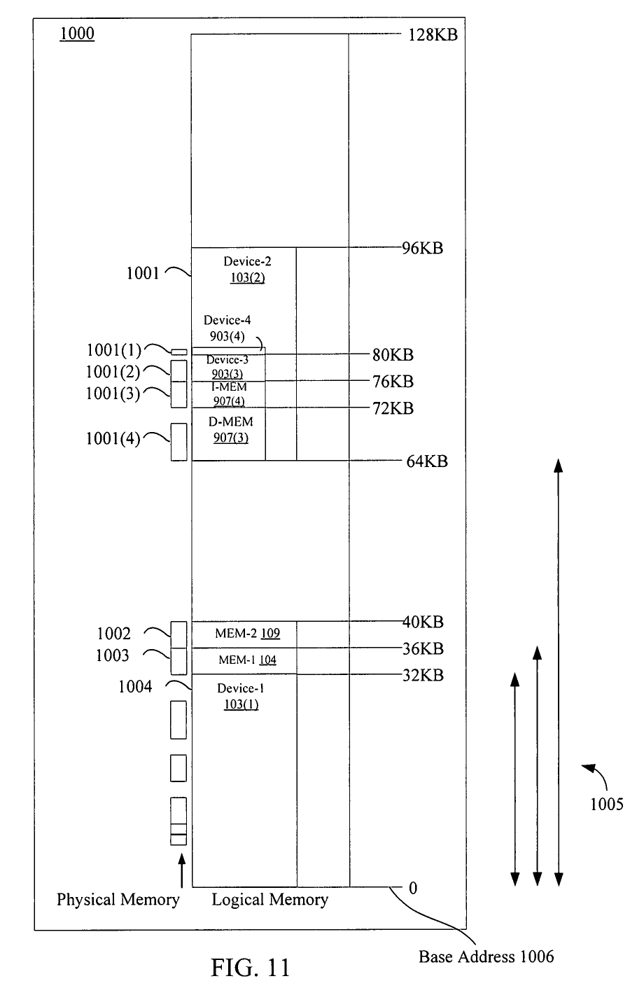

At the next higher level of hierarchy (application Engine 102 of FIG. 1), the bus controller memory address map is constructed in a similar way. The variable length decoder (not illustrated) of the bus controller 106 of the application engine 102 is configured to handle the following objects (only address bits shown this time): Device-1 103(1) (15-bits), Device-2 103(2) (15-bits), first memory 104 (12-bits), and second memory 109 (12-bits) (illustrated in FIG. 1). Given these sizes, at least 17-bit address decoding would be used for the application engine 102. One possible variable-length encoding of the address mapping is described in Table 1-4. FIG. 11 illustrates an address mapping space 1100 for resources of the application engine 102 of FIG. 1.

TABLE 1-4

| Bit[16] | Bit[15] | Bit[14] | Bit[13] | Bit[12] | Mapping |
|---|---|---|---|---|---|
| 0 | 0 | addr[14] | addr[13] | addr[12] | Device-1 |
| | | | | | 103(1) |
| 0 | 1 | 0 | 0 | 0 | Memory 104 |
| 0 | 1 | 0 | 0 | 1 | Memory 109 |
| 1 | 0 | addr[14] | addr[13] | addr[12] | Device-2 |
| | | | | | 103(2) |

In one embodiment, the bus controller 106 for the application engine 102 is configured with “17” as the internal address mask size. The bus controller 106 is also configured with the unique base address of the application engine 102 in the global address space. The transactions generated at this level of hierarchy can be routed “down” to the device 103(2) if the transaction address lies in the range of the address space of that device. Alternatively, the transactions generated at this level of hierarchy can be routed “up” to the system bus 110 if the upper bits of the transaction address outside the 17 bit mask are not the same as the base address of the application engine 102. All other transactions generated at this level are responded to by devices at this level.

### System Address Mapping and Relocation

As illustrated in FIG. 11, the address space 1000 of the application engine 102 is hierarchically composed of the address spaces 1001-1004 of its sub-systems (e.g., first and second devices 103(1) and 103(2), and first and second memories 104 and 109) that are placed at fixed offsets 1005 relative to the base address 1006 of the application engine 102. Also, the address space 1000 also indicates the address spaces 1001(1)-1001(4) of the resources of the second device 103(2). The application engine 102 is a client (e.g., slave device) on the system bus 110 to the host 101 (e.g., master device). The address space 1000 of the application engine 102 can be mapped at any address position in the system address space that is aligned to a power-of-2 boundary equal to the size of the application engine's address space.

Both static and dynamic address space configurations are possible. In one embodiment, the base address 1006 of the application engine 102 is selected and hardwired at system design time. This base address is supplied as a constant to the root bus controller 106 of the application engine 102. In another embodiment, the base address 1006 is a programmable base address. In one embodiment, the base address 1006 is dynamically programmed in a base-address register within the system bus adapter 105 that connects the uplink from the root bus controller 106 to the system bus 110. By having a programmable base address, the address space 1000 of the application engine 102 may be relocated within the system 100 dynamically while the system is running.

In one embodiment, embedded processors within the application engine 102 access their own instruction memory (e.g., 907(4)) or data memory (e.g. 907(3)) using local addressing over P2P connections. However, every globally visible data object in the system 100 is given a unique global address so that it can be accessed easily in software via a global pointer from anywhere in the system 100. In the embodiment of a hardwired, static base address for the application engine 102, this is achieved by providing the adjusted base address of the data memory to the linker (e.g., static base address 1006 plus the corresponding fixed offset 1005). All data structures residing in that memory are adjusted for that base address at link time when the linker resolves all global symbol references with static addresses to create an executable image of the program. There may be more than one data memory in the system 100, each of which has a unique base address in the system address map.

In the embodiment where the base address 1006 is a dynamic, relocatable base address, the compiler generates code which computes the global address of a data structure dynamically using the base address 1006 (e.g., stored in the programmable base-address register) plus the corresponding fixed offset 1005. At system configuration time, the relocatable base addresses of a processor's own data memory (e.g., 907(3)) and instruction memory (e.g. 907(4)) may be made available into pre-designated configuration registers within the processor 108. The program can, therefore, access any dynamically relocatable data structure in its data memory or instruction memory.

### Arbitration

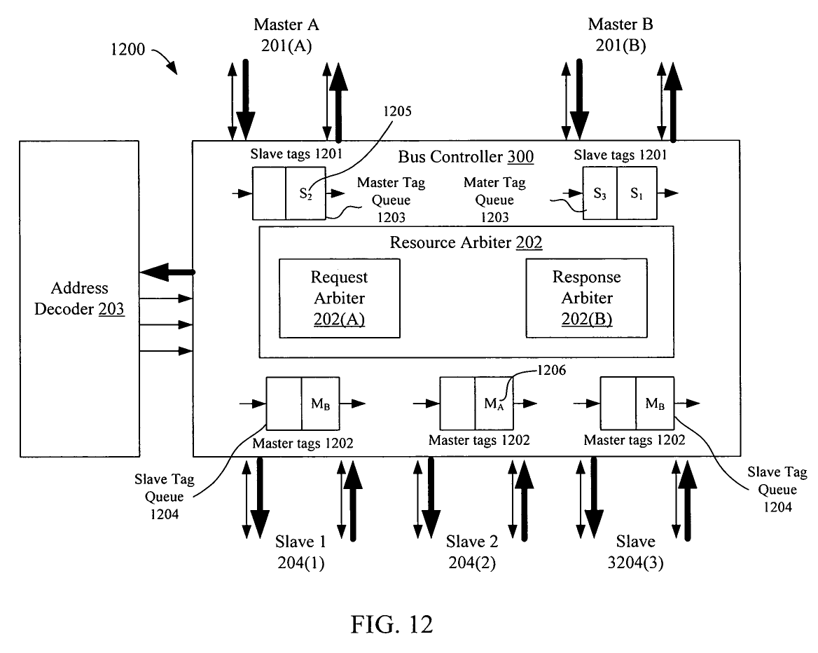

As described above, the bus controller (e.g., 106 or 300) is responsible for maintaining FIFO semantics for each master-device or slave-device link to which it connects. Many different micro-architectures are possible depending on the degree of independence and parallelism desired. An exemplary embodiment of an arbitration mechanism for maintaining the FIFO semantics is described with respect to FIG. 12.

FIG. 12 illustrates an arbitration mechanism 1200 for maintaining the FIFO semantics according to one embodiment of the invention. Since the latencies of various slave devices 204(1)-204(4) could be different, a simple way to keep track of FIFO ordering is by tagging the request from the master devices 201(A)-201(C) and matching them up with responses from the slave devices 204(1)-204(4). The tag book-keeping is kept internal to the bus controller, and the external protocol does not see, or use, any tags. On the other hand, in conventional protocols, the tags may be carried along with the data buses to master or slave devices which then need to sort the transactions in software or in hardware using those tags. The tag book-keeping of the request-response ordering information is shared between the request arbiter 202(A) and the response arbiter 202(B) in order to maintain FIFO semantics. In one embodiment, the tags record only topological information, i.e., which master device requested which slave device, and thus, are independent of spatial (data width) and temporal (latency) configurations.

At each cycle of the embodiment of FIG. 12, the incoming master-device requests are arbitrated by the request arbiter 202 and the winning master device's request is forwarded to the appropriate slave device. The appropriate slave device is determined by decoding the request address by the address decoder 203. In one embodiment, the address decoder 203 is a variable-length decoder. Alternatively, a fixed-length decoder may be used if the global address mapping at this level uses fixed length address codes.

In the embodiment of FIG. 12, the address decoder 203 is separate from the bus controller (106 or 300) and is accessed by a bus of one or more signal lines. In another embodiment, the address decoder 203 is integrated within the bus controller (106 or 300), as illustrated in the bus controller 106 of FIG. 2.

In one embodiment, if the request is a load or exchange from a master device A 201(A) to the slave device 2 204(2), then for proper response ordering, the requested slave-device identification 1205 (S₂) is added to the master tag queue 1203 at the master device's 201(A) response port and the corresponding master-device identification 1206 (M_{A}) is added to the slave tag queue 1204 at the slave's 204(2) response port. The depth of the tag queues determines the number of outstanding load transactions that can be handled. This parameter may be determined either empirically or structurally based on the expected latency of the slave devices 204(1)-204(4) in this sub-tree. In another embodiment, this tagging may be done for write transactions also if they need to be acknowledged with a response.

As described above, the request arbiter 202 enforces external master device priority but is free to provide prioritized or round-robin access to local master devices. The request arbiter 202 may also choose to make the arbitration decision solely on the basis of incoming master-device requests, or also include information on which slave devices 204 are busy. The latter information is useful in providing non-blocking access to a lower priority request, if a high priority request cannot be granted due to a busy slave device. Since the request grant signal from a slave device may be a late arriving signal, a buffer may be added close to each of the slave devices 204 to adjust the timing of this path, as described above.

The response arbitration happens in a similar fashion. At each cycle, the response arbiter 202 selects the highest priority master device for which a response is available. It is important to keep the same arbitration priority between the request and the response arbiters 202A and 202B to avoid deadlocks. The master-device tags saved at the head of the slave tag queues help in identifying the master devices for which a response is available. As shown in FIG. 12, if the slave devices 204(2) and 204(3) have an available response on a cycle, then the master device 201(A) is allowed to receive the response from slave device 204(2) first because the master device 201(A) has the highest property. Finally, FIFO ordering is enforced at the master device's response ports by dispatching the responses only in the order of the slave tags saved in the master tag queue 1203. An available response to the winning master device is forwarded only if the slave tag at the head of the master tag queue matches the tag of the responding slave. As shown in FIG. 12, if the slave device 204(3) has a response available for master device 201(B), it cannot be forwarded to the master device 201(B) because it is expecting to receive a response from slave device 204(1) first. This ensures that each master device receives responses from slave devices only in the order in which it made requests to those slave devices.

When there is only one slave device 204 (as is the case for the bus controllers 300 of FIG. 9), the tagging arrangement may be simplified considerably by keeping only a single slave tag queue 1204 at the slave device's response port. The tag of the winning master device is added to the queue when a request is issued to the slave device. This tag is used to determine the identity of the master device 201(A)-201(C) to which the next response needs to be forwarded.

In one embodiment, the arbitration process is performed by processing logic. The processing logic may include hardware (circuitry, dedicated logic, etc.), software (such as software run on a general purpose computer system or a dedicated machine), or a combination thereof. In one embodiment, the bus controller (e.g., 106 or 300) includes a processor and a memory. The memory stores instructions thereon that, when executed by the processor, cause the processor to perform the operations described above with respect to the bus controller. For example, the memory may store instructions that, when executed by the processor, cause the processor to perform the arbitration process (e.g., operations of the resource arbiters) according to the flexible bus protocol described herein. Although the processor and memory of the bus controller has not been illustrated, instructions stored in memory and executed by a processor are known to those of ordinary skill in the art, and accordingly, a detailed description of these components has not been included. In other embodiments, the bus controller includes other types of processing logic to control the bus transactions according to the flexible bus protocol as described above. This processing logic may include hardware, software, firmware, or a combination thereof.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. An apparatus, comprising
a bus controller to handle a plurality of bus transactions between a first pair of requesting and responding devices, wherein the plurality of bus transactions are pipelined, variable latency bus transactions, and wherein the bus controller is configured to maintain first-in-first-out (FIFO) ordering of the plurality of bus transactions between the first pair of requesting and responding devices even when the plurality of bus transactions take a variable number of cycles to complete.

2. The apparatus of claim 1, wherein the bus controller is configured to maintain the FIFO ordering without blocking a bus transaction between a second pair of requesting and responding devices.

3. The apparatus of claim 2, wherein each of the plurality of bus transactions between the first pair is either a request transaction or a response transaction, wherein the bus controller further comprises:
a request arbiter circuit coupled to a first request port of each of the requesting devices of the first and second pairs, wherein the request arbiter is configured to receive the request transactions of the plurality of bus transactions and the bus transaction between the second pair, wherein the request arbiter circuit is configured to send each of the request transactions to a second request port of responding device of the first pair and the bus transaction to a third request port of the responding device of the second pair, and
a response arbiter circuit coupled to a first response port of each of the responding devices of the first and second pairs, wherein the response arbiter is configured to receive the response transactions of the plurality of bus transactions from the responding device of the first pair and the bus transaction between the second pair, wherein the response arbiter circuit is configured to send the response transactions of the plurality of bus transactions to a second response port of the requesting device of the first pair and the bus transactions between the second pair to a third response port of the requesting device of the second pair.

4. The apparatus of claim 3, wherein the request arbiter is configured to perform a two-way handshake between the pair of requesting and responding devices for each of the request transactions of the plurality of bus transactions, and wherein the response arbiter is configured to perform a two-way handshake between the pair of requesting and responding devices for each of the response transactions of the plurality of bus transactions.

5. The apparatus of claim 1, wherein the bus controller comprises an address decoder coupled to receive the plurality of bus transactions, and wherein the address decoder is configured to decode a transaction address of each of the plurality of bus transactions.

6. The apparatus of claim 5, wherein the address decoder is a variable-length address decoder configured to decode addresses of variable length.

7. The apparatus of claim 2, wherein the requesting device of the second pair has a higher arbitration priority than the requesting device of the first pair, wherein the bus controller is configured to receive the bus transaction from the requesting device of the second pair during a first cycle in which a first request transaction of the plurality of bus transactions is also received, wherein the bus controller is configured to process the bus transaction from the requesting device of the second pair before the first request transaction.

8. The apparatus of claim 3, wherein the plurality of bus transactions each comprise a plurality of request signals and a plurality of response signals as part of the two-way handshake, and wherein the plurality of request signals comprise:
a request valid signal to indicate that a request transaction of the plurality of request transactions is valid;
a request mode signal to indicate at least one of a mode, a size, or a type of the request transaction;
a request address signal including a transaction address of the request transaction;
a request data signal including request data of the transaction request; and
a request grant signal to indicate that the request transaction is granted access by the slave device, wherein the plurality of response signals comprises:
a response accept signal to indicate that the master device has accepted a response transaction from the slave device;
a response valid signal to indicate that the response transaction is valid; and
a response data signal including response data of the response transaction.

9. The apparatus of claim 1, further comprising a buffer between the requesting device and the responding device to provide timing insulation for the plurality of request signals and for the plurality of response signals, and wherein the bus controller is configured to maintain the FIFO ordering without blocking a bus transaction between a second pair of requesting and responding devices using the buffer.

10. The apparatus of claim 1, wherein the bus controller is configured to run in a normal transfer mode of data transfers and a burst data transfer mode.

11. The apparatus of claim 1, wherein the bus controller is configured to handle both shared bus transactions and point-to-point (P2P) bus transaction.

12. A system, comprising:
a plurality of devices, wherein each of the plurality of devices is configured to send and receive a plurality of bus transactions; and
a plurality of bus interconnects coupled between the plurality of devices, wherein each of the plurality of bus interconnects are controlled by a bus controller, wherein the bus controller is configured to process the plurality of bus transactions in a pipelined manner, and to maintain first-in-first-out (FIFO) ordering of the plurality of bus transactions between a first pair of master and slave devices of the plurality of devices even when the plurality of bus transactions take a variable number of cycles to complete.

13. The system of claim 12, wherein the bus controller is configured to maintain the FIFO ordering without blocking a bus transaction between a second pair of master and slave devices of the plurality of devices.

14. The system of claim 12, wherein each of the plurality of bus transactions is either a shared bus transaction or a point-to-point (P2P) bus transaction, wherein the bus controller is configured to handle both the shared bus transaction and the P2P bus transaction, and wherein the bus controller is configured to process the shared bus transaction and the P2P bus transaction in a first-in-first-out (FIFO) manner.

15. The system of claim 12, wherein the plurality of bus interconnects comprises a plurality of shared bus interconnects and a plurality of P2P bus interconnects, wherein each of the plurality of shared bus interconnects is a hierarchical bus that is configured to handle a plurality of master devices and a plurality of slave devices at each hierarchy level while providing a single address space for the system, and wherein the single address space for the system comprises a programmable base address and fixed offset addresses for the plurality of devices from the programmable base address.

16. The system of claim 15, wherein each bus controller of the plurality of bus interconnects comprise a plurality of request ports to receive a plurality of request transactions from a plurality of master devices and a plurality of response ports to receive a plurality of response transactions from a plurality of slave devices, and wherein each bus controller is configured to prioritize a first request port of the plurality of request ports as a highest priority for arbitration of the plurality of request transactions over the other request ports of the plurality of request ports to avoid deadlock for shared bus transactions.

17. A bus controller, comprising:
a first plurality of ports to receive a plurality of request transactions from a plurality of master devices;
a second plurality of ports to receive a plurality of response transactions from a plurality of slave devices; and
an arbiter circuit coupled to the first plurality of ports and the second plurality of ports, wherein the plurality of request transactions and the plurality of response transactions are pipelined, variable latency bus transactions, and wherein the arbiter circuit is configured to maintain request first-in-first-out (FIFO) ordering of the plurality of request transactions and response FIFO ordering of the plurality of response transactions between a first pair of master and slave devices of the plurality of master and slave devices.

18. The bus controller of claim 17, wherein the arbiter circuit is configured to maintain the request and response FIFO orderings without blocking a bus transactions between a second pair of master and slave devices.

19. The bus controller of claim 18, wherein the arbiter circuit is configured to prioritize a first port of the first plurality of ports as a highest priority for arbitration of the plurality of request transactions over the other ports of the first plurality of ports to avoid deadlock, and wherein the arbiter circuit is configured to prioritize the other ports as at least one of equal priority or full priority for arbitration of the plurality of request transactions.

20. A method, comprising:
receiving a plurality of bus transactions from a first bus interconnect, wherein the plurality of transactions are pipelined, variable latency bus transactions between a first pair of master and slave devices; and
maintaining first-in-first-out (FIFO) ordering of the plurality of bus transactions between the first pair of master and slave devices, wherein maintaining the FIFO ordering comprises sequentially processing the plurality of transactions in order even when the plurality of bus transactions take a variable number of cycles to complete.

21. The method of claim 20, further comprising receiving a bus transaction from a second bus interconnect, wherein the bus transaction is between a second pair of master and slave devices, and wherein the FIFO ordering is maintained without blocking the bus transaction between the second pair.

22. The method of claim 21, further comprising prioritizing a first incoming port that is coupled to the second bus interconnect as a highest priority over a second incoming port that is coupled to the first bus interconnect to avoid deadlock in arbitration of the plurality of bus transactions and the bus transaction.

23. The method of claim 20, wherein the plurality of bus transactions comprise a plurality of request transactions and a plurality of response transactions, wherein processing the plurality of request transactions comprises performing a two-way handshake for each of the plurality of request transactions between the master device and the slave device of the first pair, and wherein processing the plurality of response transactions comprises performing a two-way handshake for each of the plurality of response transactions between the slave device and the master device of the first pair.

24. The method of claim 20, wherein receiving the plurality of transactions comprises receiving a burst request transaction, wherein receiving the burst request transaction comprises:
receiving a first-of-transfer (FOT) request to set up an end-to-end path between the master device and the slave device of the first pair, wherein the end-to-end path is set up by maintaining a grant selection until an end-of-transfer (EOT) request is received;
receiving burst data from the master device in one or more data transfers in one or more cycles, wherein each of the one or more data transfers indicates a continue (CNT) request or the EOT request; and
receiving the EOT request, and wherein the end-to-end path is taken down by releasing the grant selection after receiving the EOT.

25. The method of claim 24, wherein receiving the plurality of transactions comprises receiving a burst response transaction, wherein receiving the burst response transaction comprises receiving a FOT response that indicates that the slave device is ready to receive the burst data, wherein the master device is configured to send the burst data upon receiving the FOT response from the slave device.
